(19) United States
(12) Patent Application Publication
(10) Pub. No.: US 2019/0370615 A1
(43) Pub. Date: Dec. 5, 2019

(54) State machine methods and apparatus comprising work unit transitions that execute acitons relating to natural language communication, and artifical intelligence agents to monitor state machine status and generate events to trigger state machine transitions

(71) Applicant: Talla, Inc., Brookline, MA (US)

(72) Inventors: William MURPHY, San Mateo, CA (US); Matt MCMILLAN, Andover, MA (US); Jon KLEIN, Medford, MA (US); Robert MAY, Brookline, MA (US); Byron GALBRAITH, Quincy, MA (US)

(21) Appl. No.: 16/399,586

(22) Filed: Apr. 30, 2019

Related U.S. Application Data
(63) Continuation of application No. PCT/US2017/059408, filed on Oct. 31, 2017.
(60) Provisional application No. 62/415,352, filed on Oct. 31, 2016.

(51) Int. Cl. G06K 9/62; G06N 20/00; G06F 17/27; G06F 9/54

(52) U.S. Cl. CPC G06K 9/6278; G06K 9/6217; G06F 9/541; G06F 17/2765; G06N 20/00

(57) ABSTRACT

State machine methods and apparatus improve computer network functionality relating to natural language communication. In one example, a state machine implements an instance of a workflow to facilitate natural language communication with an entity, and comprises one or more transitions, wherein each transition is triggered by an event and advances the state machine to an outcome state. One or more state machine transitions comprise a work unit that executes one or more computer-related actions relating to natural language communication. An artificial intelligence (AI) agent implements one or more machine learning techniques to monitor inputs/outputs of a given work unit and the respective outcome states of the state machine to determine a status or behavior of the state machine. The AI agent also may generate one or more events to trigger one or more transitions/work units of the state machine, based on one or more inputs monitored by the AI agent and one or more of the machine learning techniques.

### CROSS-REFERENCE TO RELATED APPLICATIONS

This application claims the priority benefit to U.S. Application 62/415,352, entitled “Systems, Apparatus, and Methods for Platform-Agnostic Workflow Management,” filed on Oct. 31, 2016, the disclosure of which is incorporated herein by reference in its entirety.

### TECHNICAL FIELD

The present disclosure relates generally to systems, apparatus, and methods for workflow management. More specifically, the present disclosure relates to systems, apparatus, and methods for designing, monitoring, managing, and executing workflows over multiple platforms.

### BACKGROUND

A workflow may be considered a representation of a process or repeatable pattern of activity including systematically organized components to, for example, provide a service, process information, or create a product. Components may include steps, tasks, operations, or subprocesses with defined inputs (e.g., required information, materials, and/or energy), actions (e.g., algorithms which may be carried out by a person and/or machine), and outputs (e.g., produced information, materials, and/or energy) for providing as inputs to one or more downstream components. Some software systems support workflows in particular domains to manage tasks such as automatic routing, partially automated processing, and integration between different software applications and hardware systems.

### SUMMARY

Systems, apparatus, and methods are disclosed for performing computer-related and internet-related activity for a particular audience. In various implementations, such systems, apparatus, and methods implement one or more artificial intelligence agents in order to complete the computer and internet related activity.

In some inventive aspects, a system to improve computer network functionality relating to natural language communication includes at least one communication interface to communicatively couple the system to at least one computer network. The system also includes a first state machine to implement a first instance of a workflow to facilitate first natural language communication with a first entity. The first state machine includes a first transition comprising a first work unit to execute at least one first computer-related action relating to the first natural language communication with the first entity. The first work unit is triggered by a first event. The first state machine is in a first outcome state upon completion of the first work unit. The first state machine also includes a second transition comprising a second work unit to execute at least one second computer-related action relating to the first natural language communication with the first entity. The second work unit is triggered by a second event. The first state machine is in a second outcome state (2002B) upon completion of the second work unit. The system also includes an artificial intelligence (AI) agent. The AI agent comprises an AI communication interface communicatively coupled to the at least one communication interface and the first state machine to receive first state machine information from at least the first state machine. The AI agent implements at least one machine learning technique to process the first state machine information to determine first state machine observation information regarding a behavior or a status of the first state machine.

In some inventive aspects, a system to improve computer network functionality relating to natural language communication includes at least one communication interface to communicatively couple the system to at least one computer network. The system also includes a first state machine to implement a first instance of a workflow to facilitate first natural language communication with a first entity. The first state machine includes a first transition comprising a first work unit to execute at least one first computer-related action relating to the first natural language communication with the first entity. The first work unit is triggered by a first event. The first state machine is in a first outcome state upon completion of the first work unit. The system also includes an artificial intelligence (AI) agent, communicatively coupled to the at least one communication interface and the first state machine, to implement at least one machine learning technique to dynamically generate at least the first event that triggers the first work unit.

In some inventive aspects, a system to improve computer network functionality relating to natural language communication includes at least one communication interface to communicatively couple the system to at least one computer network. The system also includes a first state machine to implement a first instance of a workflow to facilitate first natural language communication with a first entity. The first state machine includes a first plurality of work units to execute first respective computer-related actions relating to the first natural language communication with the first entity. The first plurality of work units are respectively triggered by a corresponding plurality of first events and have a corresponding plurality of first outcome states. The system also includes a second state machine to implement a second instance of the workflow to facilitate second natural language communication with a second entity. The second state machine includes a second plurality of work units to execute the first respective computer-related actions relating to the second natural language communication with the second entity. The second plurality of work units are respectively triggered by a corresponding plurality of second events and have a corresponding plurality of second outcome states. The system also includes an artificial intelligence (AI) agent, comprising an AI communication interface communicatively coupled to the at least one communication interface. The first state machine and the second state machine receive first state machine information from at least the first state machine and second state machine information from the second state machine and implement at least one machine learning technique to process the first state machine information and the second state machine information to determine observation information regarding the first state machine and the second state machine.

In some inventive aspects, a system to improve computer network functionality relating to natural language communication includes at least one communication interface to communicatively couple the system to at least one computer network. The system also includes a first state machine to implement a first instance of a workflow to facilitate first natural language communication with a first entity. The first state machine includes a first plurality of work units to execute first respective computer-related actions relating to the first natural language communication with the first entity. The first plurality of work units are respectively triggered by a corresponding plurality of first state machine events and have a corresponding plurality of first state machine outcome states. The system also includes a second state machine to implement a second instance of the workflow to facilitate second natural language communication with a second entity. The second state machine includes a second plurality of work units to execute the first respective computer-related actions relating to the second natural language communication with the second entity. The second plurality of work units are respectively triggered by a corresponding plurality of second state machine events and have a corresponding plurality of second state machine outcome states.

In some inventive aspects, a computer-implemented method of generating and implementing a first sequence of logical work units to accomplish at least one job includes generating, via at least one of an artificial intelligence agent and an admin portal, the first sequence of the logical work units, each work unit in the first sequence of logical work units being an active action to be implemented by at least one of a user, the artificial intelligence agent, a dispatch controller, a processing and routing controller, and a task performance controller. The method also includes defining, via at least one of the artificial intelligence agent and the admin portal, a first campaign including a first audience for the first sequence of logical work units, the first audience being a plurality of individuals interacting with the first sequence of logical work units. The method also includes triggering the first campaign with an event. The method further includes implementing, via a processor, at least one instance of the first sequence of logical work units for at least one individual in the plurality of individuals defined by the first campaign and triggering a second campaign based at least in part on the outcome of the at least one instance of the first sequence of logical work units, the second campaign defining a second audience to interact with a second sequence of logical work units. The artificial intelligence agent is an independent entity including a plurality of machine learning modules and at least one decision policy configured to implement a non-deterministic function. The outcome of the second sequence of logical work units completes the at least one job.

In some inventive aspects, a system includes means for generating a sequence of repeatable logical work units to accomplish at least one job, means for defining a campaign including an audience for the sequence of repeatable logical work units, means for triggering the campaign with an event, and means for implementing at least one instance of the sequence of repeatable logical work units for at least one individual in the audience defined by the campaign.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Other systems, processes, and features will become apparent to those skilled in the art upon examination of the following drawings and detailed description. It is intended that all such additional systems, processes, and features be included within this description, be within the scope of the present invention, and be protected by the accompanying claims.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a schematic illustration of a workflow system for implementing workflows in accordance with some inventive aspects.

FIG. 2 is an illustration of an example Finite State Machine (FSM) implementing a workflow, in accordance with some inventive aspects.

FIG. 3 is a simplified illustration of a workflow in accordance with some inventive aspects.

FIG. 4 is an illustration of an intelligent workflow with an artificial intelligence work unit in accordance with some inventive aspects.

FIG. 5 is an example illustration of artificial intelligence monitors with workflows for monitoring workflows intelligently in accordance with some inventive aspects.

FIG. 6 is a flow diagram illustrating a campaign event triggering a campaign to initiate instances of a workflow in accordance with some inventive aspects.

FIG. 7 is a flow diagram illustrating a campaign triggered by the output of a work unit of a workflow in accordance with some inventive aspects.

FIG. 8 illustrates one implementation of workflow instances in accordance with some inventive aspects.

FIG. 9 illustrates a second implementation of workflow instances in accordance with some inventive aspects.

FIG. 10 illustrates a third implementation of workflow instances in accordance with some inventive aspects.

FIG. 11 is a block diagram of a system integrated with the workflow system in FIG. 1 to create and implement workflows in accordance with some inventive aspects.

FIG. 12 is a flow diagram illustrating a high-level overview of processing an incoming message in accordance with some inventive aspects.

FIG. 13 is a block diagram illustrating a dispatch controller in accordance with some inventive aspects.

FIG. 14 is a flow diagram illustrating a method for dispatching an incoming message in accordance with some inventive aspects.

FIG. 15 is a block diagram illustrating a processing and routing controller in accordance with some inventive aspects.

FIG. 16 is a flow diagram illustrating operation of a series of processors in accordance with some inventive aspects.

FIG. 17 is a flow diagram illustrating operation of a sequence of routers in accordance with some inventive aspects.

FIG. 18 is a flow diagram illustrating parallel operation of routers in accordance with some inventive aspects.

FIG. 19 is a flow diagram illustrating a method for task performance in accordance with some inventive aspects.

FIG. 20 is a flow diagram illustrating a method for dispatching an outgoing message in accordance with some inventive aspects.

FIG. 21 is a screenshot of a display illustrating a user interface for making requests and receiving responses in accordance with some inventive aspects.

FIG. 22 illustrates a user interface for designing a workflow in accordance with some inventive aspects.

FIG. 23 illustrates a user interface that enables editing a workflow in accordance with some inventive aspects.

FIG. 24 illustrates a user interface that enables designing a workflow based on predefined templates in accordance with some inventive aspects.

FIG. 25A and 25B illustrates a user interface that enables designing a campaign in accordance with some inventive aspects.

FIG. 26 illustrates a user interface that enables editing a campaign in accordance with some inventive aspects.

### DETAILED DESCRIPTION

Systems, apparatus, and methods are disclosed for performing computer-related and internet-related activity for a particular audience. In various implementations, such systems, apparatus, and methods implement one or more artificial intelligence agents in order to complete the computer and internet related activity.

### Concepts and Terminology

In some inventive aspects, the computer and internet related activity can be defined as a workflow. A workflow is used herein to refer to a sequence of repeatable logical work units that when executed accomplish the activity. That is, the workflow is a structured representation of steps that when undertaken accomplish the activity. Workflow is an orderly and efficient process for retrieval and manipulation of information for natural language messaging and interaction with a user. Workflows include work units and events or triggers that transition between the work units. In some inventive aspects, workflows can be implemented as Finite State Machines (FSMs), directed graphs, directed cyclic graphs, decision tree, Merkle tree, a combination thereof, and/or the like. In some inventive aspects, a workflow may be used to define a business process.

A work unit is an active action that is executed by one or more users, one or more artificial intelligence agents, and/or the system disclosed herein. A work unit is a discrete and repeatable active action involving interaction with one or more user or one or more artificial intelligence agents. Some non-limiting examples of work unit include sending and displaying a message to a user, soliciting feedback in the form of a written response from a user, selecting an option in a poll, asking for approval, viewing a checklist, accessing fields in a database, etc.

One or more events or triggers operate to transition workflows from one work unit to another work unit. In some inventive aspects, events may define conditions under which a work unit in a workflow is considered completed and the next work unit in the workflow sequence has begun. Some non-limiting examples of events include time delay, a predetermined and preprogrammed time of the day, receiving a message, clicking a button, submitting a response, etc. In some inventive aspects, events or triggers for a work unit may be compounded. For example, a trigger that operates to transition from a first work unit to a second work unit may be a timeout or the click of a button.

An outcome of implementing a work unit refers to successful completion of the work unit or whether or not the work unit has been triggered.

The outcome of implementing a work unit represents a workflow state within a workflow. A workflow state is associated with an instance of a workflow. A workflow state at a point in time may represent the history of work units in the workflow that have been completed until that point in time. In some inventive aspects, the workflow state may represent the status of the workflow.

A workflow status indicates the workflow state for an instance of a workflow at a given point in time. That is, workflow state may indicate the outcome of a work unit in the workflow at a given point in time. For example, the outcome of a first work unit at a given point in time may be that the first work unit has been successfully completed and the outcome of a third work unit at that point in time may be that the third work unit has not been triggered yet. In such an instance, the workflow status for the workflow at that point in time is that the workflow is transitioning between the first work unit and the third work unit (i.e., a second work unit may be currently executing). In some inventive aspects, an artificial intelligence agent may monitor work units during execution and may indicate that a particular work unit is currently being executed (i.e., a particular work unit has been partially completed). In such instances, the workflow status of a workflow at a given point in time may indicate that a work unit is currently being executed or has been partially executed.

A bot is a computer program that monitors for incoming data and generates response data autonomously based on machine learning algorithms, heuristics, and one or more rules.

An artificial intelligence agent is an autonomous entity that can independently make decisions based on one or more inputs and take independent actions. These independent actions may be taken proactively or responsively in accordance with established objectives and/or self-originated objectives of the artificial intelligence agents. Artificial intelligence agents include one or more machine learning modules and one or more decision policies that can be implemented to perform a particular function in order to meet its established and/or self-originated objectives. The artificial intelligence agent's function can be non-deterministic. That is, the artificial intelligence agent may use supervised and/or unsupervised learning to learn and determine its function over time. In some inventive aspects, artificial agents can function as a bot.

A campaign defines audiences/entities (e.g., an individual, an organization, artificial intelligence agent) for a workflow and thus instances for the workflow. The campaign is a combination of the workflow, the entities that perform and/or otherwise engage with the workflow, and an event that will trigger the campaign.

A campaign trigger is an event and/or trigger that indicates that a campaign should begin. This initiates the first work unit in the workflow for each instance of workflow that is defined in the campaign. That is, if the campaign defines three entities and thus three instances for the workflow, the campaign trigger will initiate the first work unit in the workflow for each of the three entities. Some non-limiting examples of a campaign trigger includes a user clicking a button, a calendar event, obtaining an email with a specific subject line, a particular date and time, etc.

### Workflows and Artificial Intelligence Agents

One or more artificial intelligence agents can be integrated into and/or communicatively coupled with workflows to efficiently retrieve and manipulate information to facilitate natural language interaction with a user. Artificial intelligence agents may be configured to improve the design of the workflows. In some inventive aspects, artificial intelligence agents may reduce the computation time to complete a workflow. In some inventive aspects, artificial intelligence agents may be configured to monitor workflows thereby providing intelligent workflow management. In inventive aspects described herein, one or more users can interact and engage with workflows using multiple communication platforms.

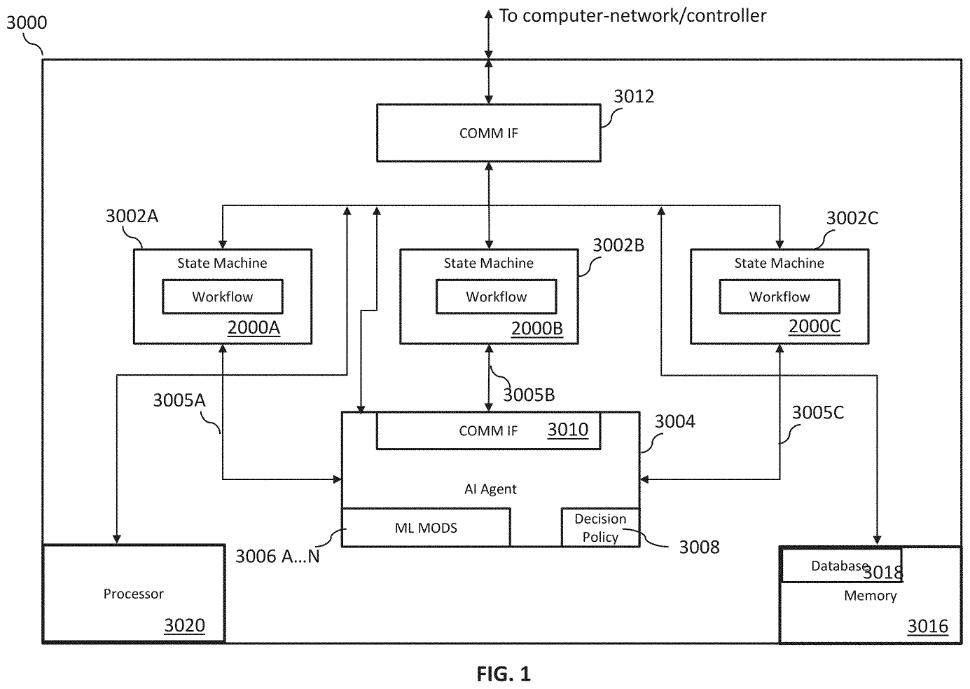

FIG. 1 illustrates an example workflow system 3000 for implementing workflows. The workflow system 3000 includes one or more Finite State Machines (FSMs), for example, 3002A, 3002B, and 3002C (collectively, FSMs 3002) implementing instances of workflows, for example, 2000A, 2000B, and 2000C (collectively, workflows 2000). The FSMs 3002 are communicatively coupled to a communications interface 3012 that is included in the workflow system 3000. One or more artificial agents, for example, artificial agent 3004 are communicatively coupled to the FSMs 3002.

The communications interface 3012 communicatively couples the workflow system 3000 to one or more computer networks. For instance, communications interface 3012 may provide the workflow system 3000 access to the Internet. The communications interface 3012 allows the workflow system 3000 to communicate and share data with one or more personal computers, computing devices, phone, server, and other networking hardware. In some instances, the communications interface 3012 may communicatively couple the workflow system 3000 to one or more controllers described herein (e.g., dispatch controller, processing and routing controller, and task performance controller). In some inventive aspects, the communications interface 3012 may expose one or more web services endpoints (e.g., HTTP endpoints) to integrate an external system (e.g., Twitter®, Gmail™, Outlook™ calendar, and/or the like) with the workflow system 3000.

In some inventive aspects, FSMs 3002 implement instances of workflow 2000. One or more events in a workflow instance 2000 operate to transition the workflow from one work unit in the workflow to another work unit in the workflow. Thus, events trigger work units and by executing work units in the workflow, the FSMs transition from one workflow state to another workflow state. In some inventive aspects, the outcome of work units in a workflow represent the workflow state for that instance of the workflow 2000. In some inventive aspects, the workflow state may represent the workflow status for that instance of the workflow 2000.

The FSMs 3002 are communicatively coupled to artificial intelligence agents 3008 via a communications interface 3010. The artificial intelligence agent 3008 includes one or more machine learning modules, for example, machine learning modules 3006A-3006N (collectively, machine learning modules 3006). In some inventive aspects, the artificial intelligence agent 3008 may access one or more machine learning modules 3006 that are included in a controller described herein (e.g., dispatch controller, processing and routing controller, task performance controller) via a web service endpoint (e.g., HTTP endpoint). Machine learning modules 3006 may include one or more machine learning algorithms and/or machine learning models. Some non-limiting examples of machine learning algorithms and models include maximum entropy classification, Naive Bates classification, k-Nearest Neighbors (k-NN) clustering, Word2vec analysis, dependency tree analysts, n-gram analysis, hidden Markov analysis, probabilistic context-free grammar, etc.

The artificial intelligence agent 3004 includes one or more decision policies such as decision policy 3008. The decision policy 3008 enables the artificial intelligence agent 3004 to proactively and responsively take independent actions in order to perform a function that is in accordance with the artificial intelligence agent's 3004 objectives. For example, consider an artificial intelligence agent 3004 that functions as an auto editor. The artificial intelligence agent 3004 implements machine learning algorithms in the machine learning modules 3006 to look-up sentences and identify possible edits for a sentence. In one case, each machine learning module 3006 may identify a possible edit. A decision policy 3008 may assign a probability score to the results that are identified by each machine learning module 3006. The probability score indicates the likelihood that the edit is appropriate in the context of the sentence. The decision policy 3008 may edit the sentence based on the highest probability score. In this manner, the artificial intelligence agent 3004 can take an independent action to perform auto edits.

In some inventive aspects, the artificial intelligence agent 3004 may utilize supervised and unsupervised learning to dynamically learn its objective. Thus, the artificial intelligence agent 3004 may have a non-deterministic function.

The artificial intelligence agent 3004 is communicatively coupled to the FSMs 3002 via communications interface 3010. In some inventive aspects, an artificial intelligence agent 3004 can trigger a campaign and hence an instance of a workflow. In other words, the artificial intelligence agent 3004 can generate a campaign trigger. For example, consider an organization that has designed a workflow to respond to increased traffic and negative comments on their website. A campaign can be defined with content managers as audience for this workflow. An artificial intelligence agent 3004 may continuously monitor web site traffic and record any anomaly in traffic including spikes in traffic or negative comments if any. The artificial intelligence agent 3004 may implement natural language understanding and detection techniques to identify negative comments. In response to detecting an anomaly, the artificial intelligence agent 3004 may generate a campaign trigger to trigger separate instances of workflow for each content manager. Thus, the communications interface 3010 may provide the campaign trigger to the FSM 3002. For example, consider FSM 3002B as implementing an instance of the workflow to respond to increased traffic and negative comments. Artificial intelligence agent 3004 detects an anomaly and generates a campaign trigger 3005B that triggers the campaign thereby triggering the first work unit within workflow 2000B. In this manner, a campaign can be initiated by an artificial intelligence agent 3004.

In some inventive aspects, the artificial intelligence agent 3004 may generate events and/or triggers to trigger one or more work units. For instance, consider a workflow designed to provide route suggestions to a user based on weather conditions. The artificial intelligence agent 3004 may monitor the weather and may generate a trigger and/or an event based on the analytics that it determines. The trigger may initiate a work unit within an instance of a workflow. For example, consider FSM 3002C as implementing an instance of a workflow that provides route suggestion based on weather conditions. Artificial intelligence agent 3004 generates a trigger 3005C to initiate the third work unit within the workflow 2000C based on the weather monitoring analytics. In this manner, events and/or triggers can be generated by an artificial intelligence agent 3004.

In some inventive aspects, the artificial intelligence agent 3004 can continuously monitor workflows, identify challenges within workflows, and suggest improvements to the workflow. For example, consider a campaign that defines all the employees of an organization as an audience for a workflow that has been designed such that the third work unit of the workflow is a long survey that must be filled by each employee. The artificial intelligence agent 3004 can monitor each instance of this workflow. If the artificial intelligence agent 3004 recognizes the third work unit as a bottleneck, the artificial intelligence agent 3004 can instruct the next instance of the workflow that is initiated to skip the third work unit and move ahead to the fourth work unit. For instance, consider FSMs 3002A and 3002B as each implementing an instance of the workflow wherein the third work unit is a long survey. The workflow 2000A implemented by FSM 3002A is initiated before the workflow 2000B is implemented by FSM 3002B. The artificial intelligence agent 3004 monitors the output 3005A of the third work unit of workflow 2000A. Once the artificial intelligence agent recognizes that the third work unit is a bottleneck based on the output 3005A, the artificial intelligence agent 3004 communicates an instruction 3005B to the FSM 3002B implementing workflow 2000B to skip the third work unit and move to the fourth work unit. In this manner, artificial intelligence agent 3004 can generate recommendations by identifying bottlenecks and verifying community behavior. Artificial intelligence agent 3004 can also optimize workflow designs.

In some inventive aspects, the artificial intelligence agent 3004 can suggest new workflows by monitoring different instances of workflows. In some inventive aspects, the artificial intelligence agent 3004 can monitor and track the history of workflow implementations and generate reports based on the history. That is, the artificial intelligence agent 3004 can monitor work units of a workflow and generate a report based on the actions that are implemented by the workflow.

In some inventive aspects, the artificial intelligence agent 3004 can monitor each instance of a workflow and provide contextual information relating to workflow states to other instances of the workflow. For example, consider FSMs 3002A, 3002B, and 3002C implementing different instances of the same workflow as 2000A, 2000B, and 2000C respectively. The artificial intelligence agent 3004 can monitor workflow states of each instance of the workflow. The artificial intelligence agent can provide context of the workflow states of workflow 2000A and workflow 2000B as input 3005C to workflow 2000C. In this manner, each instance of workflow is knowledgeable about the workflow state of each other instance of the same workflow.

In some inventive aspects, an artificial intelligence agent 3004 may monitor work units of a workflow during execution and may indicate that a particular work unit is currently being executed (i.e., a particular work unit has been partially completed). In such instances, the workflow status of a workflow at a given point in time may indicate that a work unit is currently being executed or has been partially executed. For instance, consider FSM 3002C implementing an instance of a workflow, workflow 2000C. The artificial intelligence agent 3004 monitors each work unit of the workflow 2000C. The artificial intelligence agent 3004 monitors the execution of the sub-actions, if any, within each work unit. The artificial intelligence agent 3004 determines the workflow status for workflow 2000C at a given point in time based on the monitoring of the work units. That is, an indication that at a given point in time a particular work unit is currently being implemented may represent the workflow state for workflow 2000C at that point in time.

In some inventive aspects, the artificial intelligence agent 3004 may itself be a work unit within a workflow. For instance, an artificial intelligence agent might be a second work unit in the workflow 2000A implemented by FSM 3002A. For example, consider a workflow 2000A that is designed to auto edit a sentence. The first work unit of workflow 2000A may be “ask user for a sentence.” The event of obtaining the sentence from a user triggers a second work unit which is an artificial intelligence agent. The artificial intelligence agent work unit can act as an auto editor to edit the sentence. The work unit may include sub-actions to perform smart look-up of words within the sentence, search for words, etc. The artificial intelligence agent work unit may implement each of its sub-actions involving machine learning modules and a decision policy in order to auto edit the sentence.

In some inventive aspects, the artificial intelligence agent 3004 may be an entity that implements an instance of the workflow. That is, the campaign for the workflow may define the artificial intelligence agent 3004 as one of the audience. Thus, when the campaign is triggered, an instance of the workflow for the artificial intelligence agent is initiated. The artificial intelligence agent 3004 may interact and engage with its instance of the workflow and perform and/or execute work units within its workflow.

In some inventive aspects, a memory 3016 including a database 3018 is communicatively coupled to the FSMs 2000, the artificial intelligence agent 3004, the communication interface 3012, and the processor 3020. In some inventive aspects, information and/or data monitored and processed by the artificial intelligence agent 3004 can be stored in the memory 3016. For instance, the artificial intelligence could monitor the workflow states of the workflows 2000 and store the workflow states along with a time stamp in the memory 3016. The stored data can be retrieved by the artificial intelligence agent 3004 at a later time and analyzed to determine bottlenecks within the workflow. The stored data can be analyzed by the artificial intelligence agent 3004 to provide suggestions and recommendations relating to workflows. In some inventive aspects, the artificial intelligence agents may store the outputs of the work units within a workflow in the memory 3016. In some inventive aspects, predetermined triggers for work units may be stored in the memory 3016 (e.g., time delays to trigger a work unit).

In some inventive aspects, a processor 3020 is communicatively coupled to the FSMs 2000, the artificial intelligence agent 3004, the communication interface 3012, and the memory 3016. In some inventive aspects, the processor may retrieve data from the memory 3016 and analyze the data.

As discussed above, in some inventive aspects workflows may be defined as Finite State Machines (FSMs) the represent a sequence of work units. Similarly, in some inventive aspects, workflows may be defined as directed graphs, directed cyclic graphs, decision tree, Merkle tree, a combination thereof, and/or the like.

It should be appreciated that workflows may be implemented in various manners, and that examples of specific implementations and applications are provided primarily for illustrative purposes.

### Workflows as FSMs

A work unit is an active action that is executed by one or more users, one or more artificial intelligence agents, and/or the system disclosed herein. The outcome of implementing a work unit represents a workflow state within a workflow. One or more events or triggers operate to transition workflow from one work unit and thus one workflow state within a workflow to another work unit and thus another workflow state, for example, the next work unit within a linear workflow. Thus, workflows may be defined as Finite State Machines (FSMs) the represent a sequence of work units.

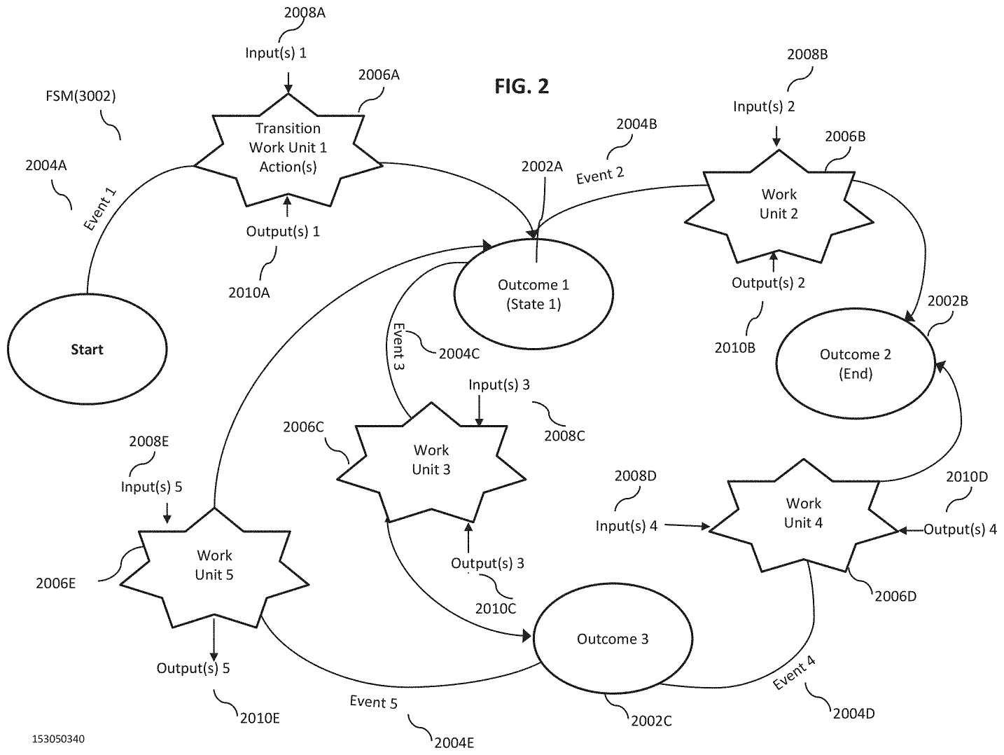

In some implementations, workflows may be implemented as FSMs. FSMs have states and transitions. In some inventive aspects, a state (also referred to herein as a “workflow state”)may be a description of the status of workflow that is waiting to execute a transition. A transition is a set of actions to be executed when a condition is fulfilled or when an event is received. FIG. 2 illustrates an example FSM 3002 implementing a workflow. As shown in FIG. 2, an event 2004, for example, 2004A, 2004B, 2004C, 2004D, and 2004E (collectively, event 2004) may trigger a work unit 2006, for example, 2006A, 2006B, 2006C, 2006D, and 2006E (collectively, work unit 2006).

In some implementations, each work unit 2006 may receive one or more input(s) 2008, for example, 2008A, 2008B, 2008C, 2008D, and 2008E (collectively, input(s) 2008) to execute the work unit 2006. For instance, in this example, work unit 2006A may receive input(s) 2008A. In some implementations, the execution of a work unit 2006 may generate one or more output(s) 2010, for example, 2010A, 2010B, 2010C, 2010D, and 2010E (collectively, output(s) 2010). For instance, in this example, the execution of work unit 2006A may generate output(s) 2010A.

The outcome of implementing the work unit 2006 may represent a workflow state 2002, for example, 2002A, 2002B, 2002C, 2002D, 2002E (collectively, workflow state 2002). For instance, in this example, the outcome of implementing work unit 2006A may represent workflow state 2002A. An outcome of implementing a work unit 2006 refers to successful completion of the work unit, or the work unit not being triggered.

As discussed above, one or more events or triggers (e.g., event2 2004B) operate to transition workflow from one work unit (e.g., work unit1 2006A) and thus one workflow state (e.g., state1 2002A)within the workflow to another work unit (e.g., work unit2 2006B) and thus another workflow state (e.g., state2 2002B) within the workflow.

In some instances, an event 2004 may be a user action, a third party action, a scheduled event, time passage, and/or output(s) 2010 of a work unit 2006 (e.g., obtaining information, broadcasting information, scheduling an event in a calendar, calculating result from data). Thus, transitions (i.e., work units 2006) between workflow states 2002 may be triggered by user actions, third party actions, scheduled events, time delays, and/or output of a work units 2006. In some inventive aspects, the transitions between workflow states 2002 may be triggered by an artificial intelligence agent. That is, the events 2004 may be generated by an artificial intelligence agent. In other words, events 2004 that trigger transition between workflow states 2002 may be dynamically determined by an artificial intelligence agent. In some inventive aspects, transitions between workflow states may be predetermined or programmed. That is, an event 2004 may be a time delay, a predetermined user action, and/or a predetermined user event.

Each work unit 2006 may include one or more sub-actions that may be implemented by one or more artificial intelligence agents, one or more users, and/or the system disclosed herein. For example, a work unit 2006 to “send a message to a user” may include sub-actions to identify a communications platform to communicate with the user, transform the message to a schema of the communications platform, and dispatch the transformed message via the communications platform to the user. In some inventive aspects, a work unit 2006 may be an artificial intelligence agent. That is, an artificial intelligence agent may implement machine learning modules and at least one decision policy to execute an active action. The artificial intelligence work unit 2006 may monitor input(s) 2008 in order to execute an active action. The executed active action may include output(s) 2010. In some inventive aspects, a work unit 2006 may be integrated with an external third party system via a third party API. The work unit 206 may execute an active action via the third party API. For instance, a work unit 2006 to broadcast a Tweet™ on Twitter® may execute this active action via Twitter® API. In some inventive aspects, each work unit 2006 may be repeatable. In some inventive aspects, a workflow is repeatable, such as, a workflow for onboarding process within an organization which may be repeated over time for one or more new employees.

In some inventive aspects, FSMs representing workflows are linear. That is, one or more triggers operate to transition workflows from one work unit and thus one state to the next work unit and thus next state. In other inventive aspects, FSMs representing workflows are cycles and/or branches.

### Work units and Workflow

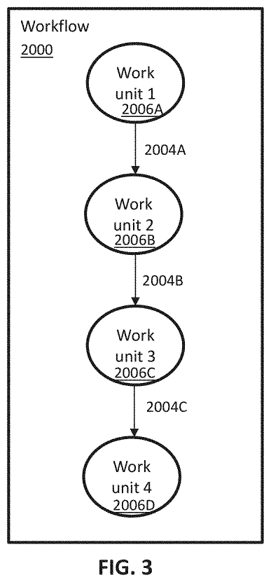

For the purposes of this disclosure, in order to emphasize the concept of work units the accompanying figures (e.g., FIG. 3 to FIG. 10), illustrate work units as ovals although they represent transitions in a FSM implementing workflows.

FIG. 3 represents a simplified illustration of workflow 2000. The workflow 2000 includes work units 2006, for example, 2006A-2006D (collectively, work units 2006). A work unit 2006 is an active action executed by one or more users, a machine learning module, an artificial intelligence agent, one or more software modules and/or routines, and/or the system disclosed herein. Each work unit 2006 may be triggered by an event such as, 2004A-2004C (collectively, events 2004). In this example, work unit 2006B is triggered by event 2004A, work unit 2006C is triggered by event 2004B, and work unit 2006D is triggered by event 2004C. An event 2004 may define conditions under which one work unit is complete and another work unit is triggered. For example, event 2004B may define conditions under which work unit 2006B is complete and work unit 2006C is triggered. An event can be generated by an external third party, or an artificial intelligence agent. In some inventive aspects, an event 2004 can be a time delay, a predetermined and preprogrammed time of the day, receiving a message, clicking a button, submitting a response.

According to some inventive aspects, an example code that defines the behavior of a work unit (e.g., work unit 2006) is included below. This example code includes the logic around details of trigger/event as well.

```
# A tableless model to manage and encapsulate logic for steps in a workflow.
class WorkflowStep
  include Virtus.model
  attribute :id, String, :default => -> (s,a) { SecureRandom.uuid }
```

| | |
|---|---|
| attribute :timeout, Boolean | # indicates whether to skip to next step, even if this step is |
| not completed | |

| | |
|---|---|
| attribute :trigger, String | # the trigger type |
| attribute :output, String | # the step output |

| | |
|---|---|
| attribute :webhook, String | # a webhook URL to hit when the step is executed |

| | |
|---|---|
| attribute :image_attachment_id, String | # an ID for an image attachment |
| attribute :notification_output, String | |

attribute :notification_targets, Hash, :default => { }

| | |
|---|---|
| attribute :key, String | # the variable name for the data collected by this step, not used by |

current workflow editor

| | |
|---|---|
| attribute :buttons, Array | # button values |

```
  attribute :checklist_items, Array, :default => [ ]
  attribute :time_offset, Integer
  attribute :time_base, String # [‘now’, ‘weekdays’, ‘days’]
  attribute :start_campaigns, Array, :default => [ ] #[ {“workflow_id”: x, “result_to_match”:
“feedback”}, {“workflow_id”: y}, ]
  def serializable_hash(opts = { })
    self.as_json.merge(:image_attachment => image_attachment.as_json(:methods => :file_url))
  end
  def image_attachment
    ImageAttachment.where(:id => image_attachment_id).first if image_attachment_id.present?
  end
  # @return [Boolean] indicates whether the trigger is a time offset
  def time_trigger?
    trigger == ‘time’
  end
  # @return [Boolean] indicates whether the trigger is a button
  def button_trigger?
    trigger == ‘button’
  end
  # @return [Boolean] indicates whether the trigger is user-inputted text
  def text_trigger?
    trigger == ‘text’
  end
  # @return [Boolean] indicates whether the trigger is a checklist text
  def checklist_trigger?
    trigger == ‘checklist’
    end
  # @return [Boolean] indicates whether there is no trigger (i.e., which could be the case on the
final step)
  def no_trigger?
    trigger == ‘none’
  end
  # @return [Boolean] indicates whether the trigger requires some user action
  def user_action_trigger?
    # If user has created step as a button trigger step but not included any buttons, treat it like it
doesn't require input.
    # TODO “better rails” on button steps to avoid this.
    text_trigger? || checklist_trigger? || (button_trigger? && @buttons.reject{|b|
b[“text”].blank? }.length > 0)
  end
  # @return [Time] the base time against which to compute time offsets
  def time_base_for_timezone(timezone, current_time = Time.current)
    case time_base
    when ‘weekdays’
      # For weekdays, we need to take every 5 weekdays, pad out to 7-day weeks,
      # then skip past weekend days. We'll factor that all into the time-base
    days = (time_offset / 1.day).floor # the day component of the offset
    days += 2 * (days / 5).floor # pad with 2 more days for each 5
    t = current_time.in_time_zone(timezone).beginning_of_day + (days * 1.day)
    loop do
      return t unless t.saturday? || t.sunday?
      t += 24.hours
    end
  when ‘days’
    return current_time.in_time_zone(timezone).beginning_of_day
  else # now
    return current_time.in_time_zone(timezone)
  end
end
def time_base
  # Legacy support - migrate to new more consistent naming/behavior
  return ‘days’ if @time_base == ‘current_day’
  return ‘weekdays’ if @time_base == ‘next_weekday’
  @time_base
end
# @return [Integer] the time offset in minutes, either relative to last step or script start
def time_offset
  offset = (@time_offset || 0).to_i
  # Legacy support - migrate “next_weekday” offset to “weekdays”.
  # “next_weekday” assumed a 1-day wait - “weekdays” starts at 0 days offset
  return offset + 24.hours if @time_base == ‘next_weekday’
  offset
end
def modified_time_offset
  if time_base == ‘weekdays’
    time_offset % 1.day
  else
    time_offset
  end
end
def next_step_time(timezone, current_time = Time.current)
  time_base_for_timezone(timezone, current_time) + modified_time_offset.seconds
  end
  def checklist_items
    @checklist_items.map.with_index { |item,idx| item[“index”] = idx.to_s; item }
  end
  def dispatch_webhook(params)
    if webhook.present?
      connection = Faraday.new(:url => webhook)
      connection.post(URI.parse(webhook).path, params)
    end
  end
end
```

According to some inventive aspects, an example code for progressing through the work units of a workflow is included below. This example code defines the behavior of a workflow state object and includes logic for storing user performance and progressing through the steps of the associated workflow.

```
class WorkflowState < ActiveRecord::Base
  belongs_to :workflow
  belongs_to :campaign
  belongs_to :profile
  belongs_to :bot
  scope :completed, -> { where(‘completed_at is NOT NULL’) }
  scope :recently_active, -> { where(‘completed_at is NULL’).where
(‘updated_at > ?’, 10.minutes.ago).order(‘updated_at DESC’) }
  after_create :schedule_time_trigger
  ACCELERATED_TEST_STEP_DELAY = 2.seconds.freeze
  def serializable_hash(opts = { })
    super(opts).merge(:profile_name => profile_name)
  end
  #formatted profile name for a campaign report
  def profile_name
    if campaign.anonymous?
      “Anonymous”
    else
      profile.fullname
    end
  def steps=(steps)
    # Ensure that defaults from WorkflowStep are properly applied
    write_attribute(:steps, steps.map{ |s| WorkflowStep.new(s) })
  end
end
```

Artificial Intelligence Work Units

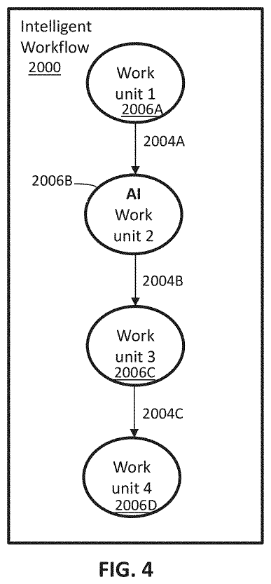

As discussed above, in some inventive aspects, one or more work units in a workflow can be artificial intelligence agents. FIG. 4 illustrates an example of an intelligent workflow 2000 with an artificial intelligence work unit. As illustrated in FIG. 4, in this example, work unit 2006B is an artificial intelligence agent. As discussed above, artificial intelligence work unit 2006B implements one or more machine learning modules along with a decision policy to execute one or more actions.

According to some inventive aspects, an example pseudocode for artificial intelligence work unit is included below.

```
# pseudocode for a work unit that converts user generated text into
sentiment scores def sentiment_analyzer(input, params):
  model = load_sentiment_analyzer(params)
  sentiment_scores = model.process(input.text)
  if sentiment_score > 0: # if positive response, continue to next
  work unit
    transition_state = input.workflow_state.next_transition_state( )
  else if sentiment_score < 0: # if negative response, jump to the end and
  responsd accordingly
    transition_state = input.workflow.finalize_state_negative( )
  return sentiment_scores
# pseudocode for an active learning work unit, where human evaluators
provide correct labels to machine learning outputs
def active_model_trainer(input, model):
  original_model_input = input.model_input
  human_corrected_label = input.corrected_label
  model.training_data.append({‘x’: original_model_input,
  ‘y’: human_corrected_label })
  model.schedule_batch_retrain( )
  return input.workflow_state.next_transition_state( )
```

In this manner, by including artificial intelligence agents as work units the workflow can display intelligence.

### Artificial Intelligence Monitors

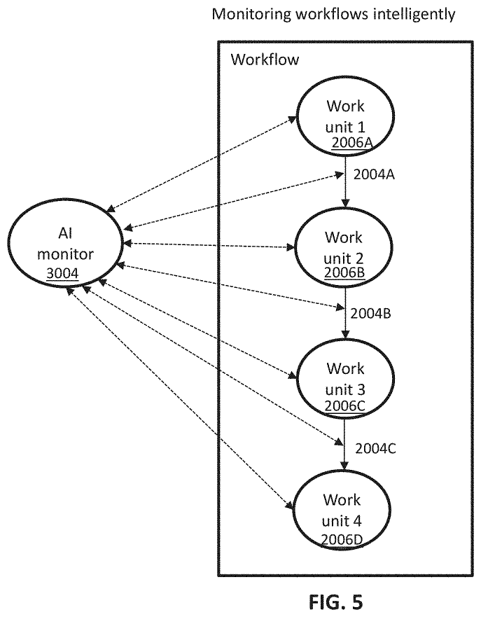

As discussed above, in some inventive aspects, artificial intelligence agents can monitor the workflows to identify challenges within workflows and suggest improvements to workflows. FIG. 5 is an example illustration of monitoring workflows intelligently. As shown in FIG. 5, artificial intelligence monitor 3004 (i.e., artificial intelligence agent) can monitor the work units 2006 as well as events 2004 of a workflow. In some inventive aspects, the artificial intelligence monitor 3004 can monitor the workflows to determine workflow status. Based on this determination, the artificial intelligence monitor 3004 can determine bottlenecks within workflows. Thus, artificial intelligence monitor 3004 can suggest improvements to workflow design.

In some inventive aspects, the artificial intelligence monitor 3004 may monitor the history of workflow implementations. That is, the artificial intelligence monitor 3004 may save the workflow status of the workflow along with a time stamp for different point in times in a database. By retrieving and analyzing the workflow status the artificial monitor can generate a report with recommendations to reduce the computational time for implementing the workflow.

In some inventive aspects, the artificial intelligence agent 3004 can monitor workflow states and provide contextual information regarding workflow states. In some inventive aspects, an artificial intelligence agent 3004 may monitor work units 2006 of a workflow during execution and may indicate that a particular work unit 2006 is currently being executed (i.e., a particular work unit has been partially completed).

### Campaigns

As discussed above, a campaign defines audiences/entities (e.g., an individual, an organization, artificial intelligence agent) for a workflow and thus instances for the workflow. That is, by triggering a campaign, instances of the workflow can be initiated for the audiences defined by the campaign. In some inventive aspects, a campaign defines a separate instance of workflow for each of the entities defined in the campaign. In some inventive aspects, a campaign defines the same instance of workflow for each of the entities defined in the campaign.

A campaign is a combination of the workflow, the entities that perform and/or otherwise engage with the workflow, and an event that will trigger the campaign. A campaign is triggered by a campaign trigger. A campaign trigger is an event and/or trigger that indicates that a campaign should begin. This initiates the first work unit in the workflow for each instance of workflow that is defined in the campaign. That is, if the campaign defines three entities and thus three instances for the workflow, the campaign trigger will initiate the first work unit in the workflow for each of the three entities. Some non-limiting examples of a campaign trigger includes a user clicking a button, a calendar event, obtaining an email with a specific subject line, a particular date and time, etc.

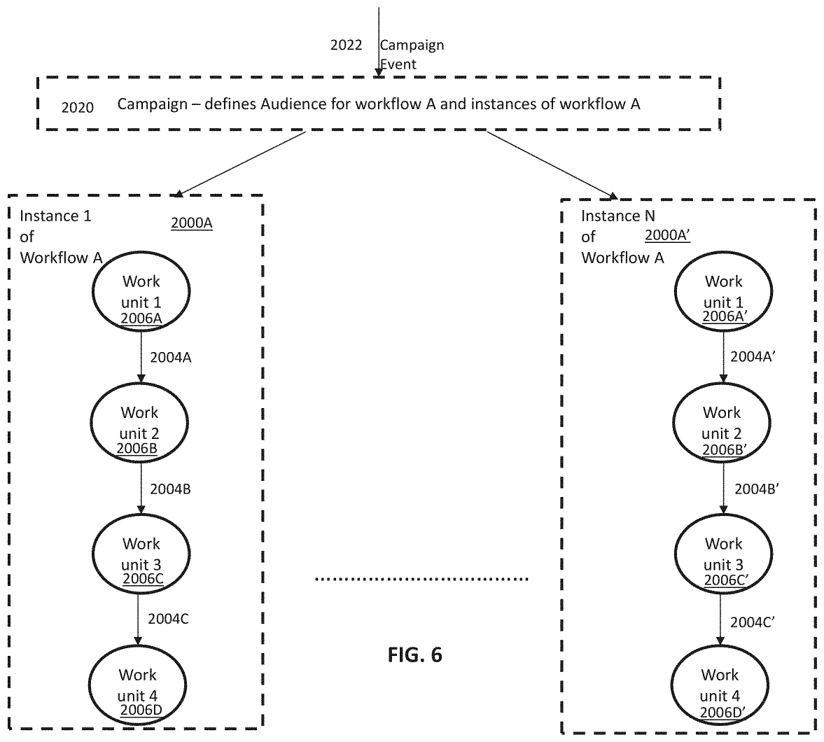

FIG. 6 is an illustration of a campaign event 2022 triggering a campaign 2020 that initiates instances of workflow 2000. As shown in FIG. 6, different instances, for example, 2000A and 2000A′ of the same workflow 2000 can be initiated by a campaign trigger 2022. Theses instance 2000A and 2000A′ may engage with and/or maybe executed by different entities. Since each instance 2000A and 2000A′ of workflow 2000 are implemented independently, at a given point in time, the workflow state for each of these instances may be different. That is, for example, at a given point in time the execution of work unit 2006C of workflow instance 2000A can be complete while the work unit 2006C′ of workflow instance 2000A′ may not yet have been triggered by 2004B′. Thus, at this point in time the workflow state of workflow instance 2000A and workflow instance 2000A′ are different.

In some inventive aspects, a campaign event 2022 initiates instances of a workflow simultaneously. In other aspects, a campaign event 2022 initiates instances of a workflow in a time-dependent manner. That is, a campaign event 2022 may initiate an instance of a workflow every two days. In still other inventive aspects, a campaign event 2022 initiates instances of a workflow in a discreet manner. In some inventive aspects, a campaign can be repeated one or more times.

In some inventive aspects, variable and parameters may be defined that are inherent to the campaign. For example, variables and parameters may define the entities/audience for the workflow, start time of the campaign, and/or a campaign trigger. In some inventive aspects, variables and parameters are placeholders in campaign that may be different for different entities. For example, the start time of a workflow may be different for different entities. Therefore, the campaign trigger 2022 may initiate instances of workflow at different times for different entities.

In some inventive aspects, a campaign trigger 2022 includes user actions, time delay, and/or internal/external system events. In some inventive aspects, a campaign trigger 2022 can be generated by an Artificial Intelligence agent. In some inventive aspects, a campaign trigger 2022 can be generated by an external application such as Google Apps™ service, Microsoft®, Office 365® apps, Trello™, Salesforce®, Google Drive™ search, and Twitter®.

A campaign is further illustrated with an example. In an organization with fifteen employees, the administrator decides to broadcast a message to each of the fifteen employees. However, the message is to be sent at a different time to a different employee. In addition, the message broadcasted varies from employee to employee. In order to accomplish this, the administrator may design a campaign and define different start time and message for each employee. An instance of workflow is initiated for each employee based on the respective start time defined in the campaign. Each instance of workflow implements the respective message defined in the campaign.

According to some inventive aspects, an example code for defining the behavior of a campaign object is included below. The code includes logic on how to handle campaign triggers, initiate instances of workflow for targeted entities. The code also includes reporting mechanisms of how each entity has performed the workflow. The code also include implementing instances of workflow separately and independently for each of the target entities.

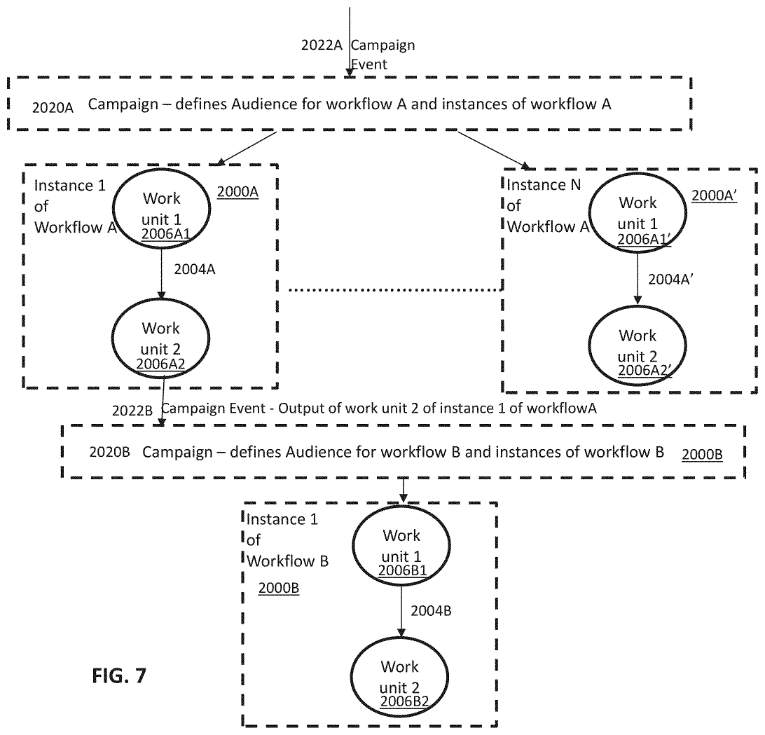

In some inventive aspects, the output of an instance of a workflow may trigger a campaign. FIG. 7 illustrates a campaign 2022B triggered by the output of a work unit 2026A2 of instance 2000A of workflowA. As shown in FIG. 7, a campaign event 2022A can trigger campaign 2020A and thereby initiate instances 2000A and 2000A′ of workflowA. The output of work unit 2006A2 of instance 2000A triggers campaign 2020B. In other words, the output of work unit 2006A2 is the campaign trigger 2022B for campaign 2020B. The campaign trigger 2022B triggers campaign 2020B, thereby initiating instance 2000B of workflowB.

### Implementing Instances of Workflow

In some inventive aspects, a campaign may be defined such that a campaign trigger initiates a separate instance of workflow for each of the entities/audience defined in campaign. In some such instances, each instance of the workflow may execute work units separately and independently of other instances of the workflow. Thus, the workflow state of respective instances of the workflow at a given point in time may be different for different instances.

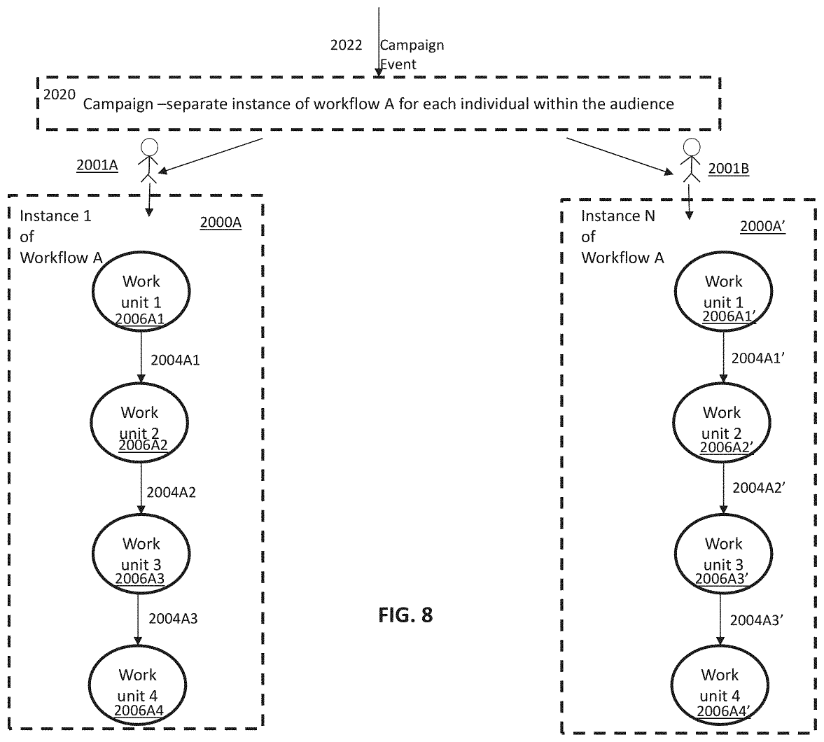

FIG. 8 illustrates a campaign 2020 that is defined for two users 2001A and 2001B. The campaign 2020 is defined such that the campaign event 2022 initiates two instances, 2000A and 2000A′ of workflowA. Workflow instance 2000A is initiated for user 2001A and workflow instance 2000A′ is initiated for user 2001B. Each work unit of these instances may be executed independently and separately. In some inventive aspects, the campaign 2020 may be defined such that workflow instance 2000A is initiated at an earlier time to workflow instance 2000A′. In other words, the campaign event 2022 may trigger work unit 2006A1 in workflow instance 2000A at an earlier time than work unit 2006A1′ in workflow instance 2000A′.

Since, the work units of each instance are executed independently and separately, at a given point in time, the workflow instances 2000A and 2000A′ may be in separate workflow states. For example, at time t1, workflow instance 2000A may have completed executing work unit 2006A2, while at the same time t1, work unit 2006A2′ in workflow instance 2000A′ may not yet be triggered. Thus, at this point in time (time t1) the workflow state of workflow instance 2000A and workflow instance 2000A′ are different.

In some inventive aspects, a campaign may be defined such that a campaign trigger initiates the same instance of workflow for each of the entities/audience defined in the campaign. In such instances, each entity defined in the campaign is in the same workflow state at a given point in time.

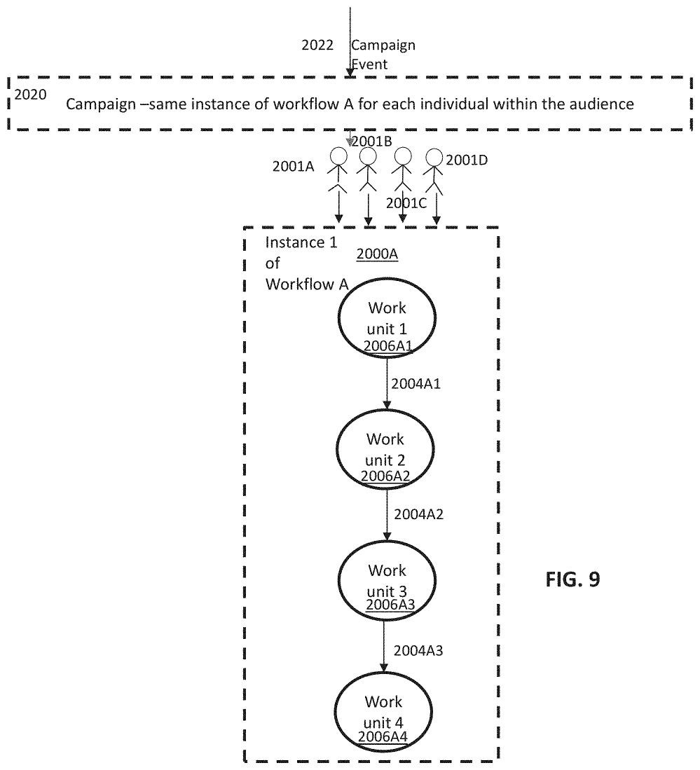

FIG. 9 illustrates a campaign 2020 that is defined for four users 2001A, 2001B, 2001C, and 2001D. The campaign is defined such that the campaign event 2022 initiates the same instance 2000A of workflowA for each of the four users. Thus, at a given point in time the workflow state for each of the four users 2001A-2001D is the same.

As discussed above, in some inventive aspects, a campaign may be defined such that a campaign trigger initiates a separate instance of workflow for each of the entities/audience defined in the campaign. In some such instances, although each instance of the workflow may execute work units separately, each instance is provided with a context of workflow state of each other instance of the workflow. Thus, although at a given point in time the workflow state of respective instances may be different for different instances, the work unit of one instance may be triggered based on the output of a work unit of another instance.

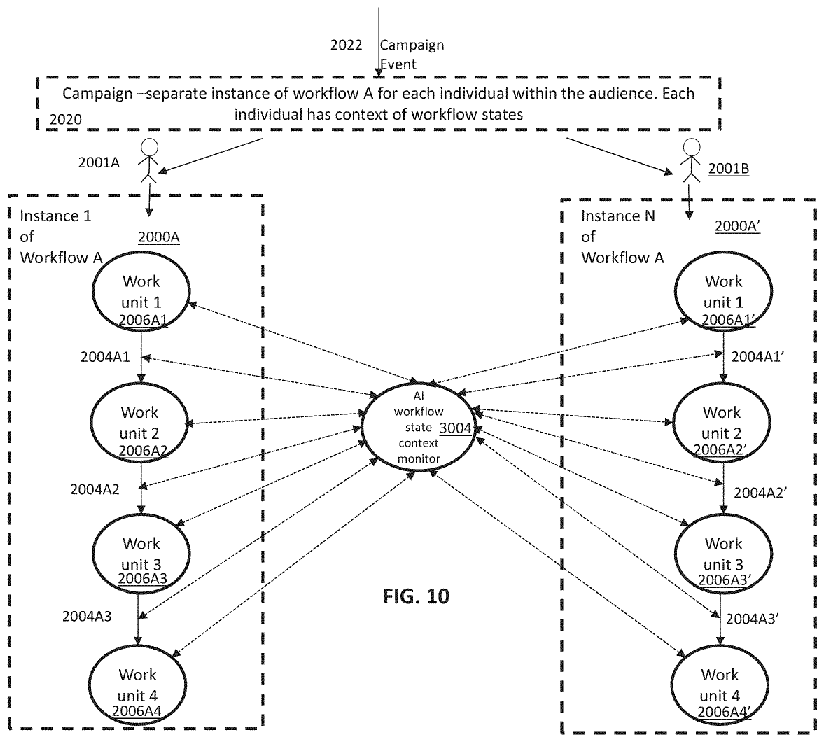

FIG. 10 illustrates a campaign 2020 that is defined for two users 2001A and 2001B. The campaign 2020 is defined such that the campaign event 2022 initiates two instances, for example, 2000A and 2000A′ of workflowA. Workflow instance 2000A is initiated for user 2001A and workflow instance 2000A′ is initiated for user 2001B. Each work unit of these instances may be executed separately. However, as discussed in the previous paragraphs, an artificial intelligence monitor 3004 can monitor the workflow state and/or the workflow status of each instance 2000A and 2000A′ of workflowA. Thus, the work unit of one instance may be triggered based on the output of a work unit of another instance.

For example, consider a workflow (e.g., workflowA) created for IT help desk department in an organization to provide technical assistance to employees in the organization. A campaign 2020 is defined to initiate instances of workflow for all users in the IT help desk department. The campaign 2020 is triggered when an employee places a help request ticket. The workflow and/or the campaign is designed such that following one user in the IT help desk department completing the workflow (i.e., solving the employee's technical problem), the instances of workflow for every other user in the IT help desk department terminates. For instance, if user 2001A completes implementing workflow instance 2000A, the artificial intelligence monitor 3004 monitoring the workflow state and/or the workflow status of instances 2000A and 2000A′ notifies workflow instance 2000A′ to terminate. Thus, the work unit in 2000A′ causing the workflow instance 2000A′ to terminate may be based on the output of the last work unit of workflow instance 2000A.

### Examples of a System Architecture to Design and Implement Workflows

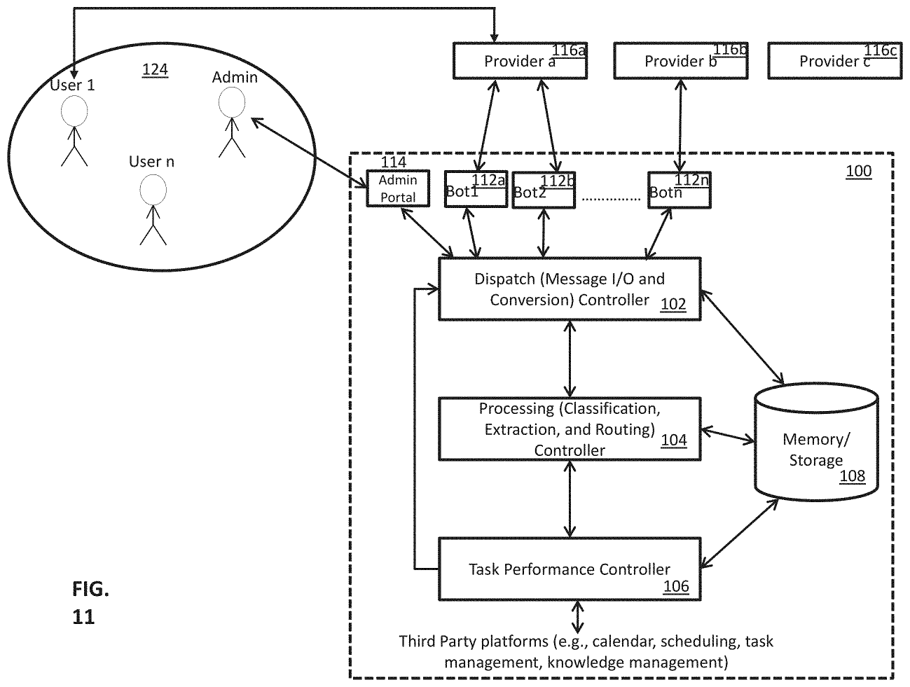

In some inventive aspects, the workflow system 3000 to implement workflows may be a standalone system. In other inventive aspects, workflow system 3000 may be integrated with other systems such as system 100 disclosed in FIG. 11 to design workflows as well as to implement workflows. System 100 in may electronically assist users to execute one or more of a variety of tasks and/or may obtain various types of information from users. In some examples, such user assistance is facilitated by processing a request or incoming message from a user (i.e., an “incoming message”), mediating the incoming message through different controllers of hardware and software architecture, and completing a task and/or sending an outgoing message to the user pursuant to the incoming message. Various implementations may be hardware and/or software platform agnostic and span across diverse technologies and services such as chat-clients, SMS, email, audio and/or video files, streaming audio and/or video data, and customized web front-ends.

FIG. 11 is a block diagram illustrating an example interaction between users in an organization 124 and a system 100 for electronically assisting the users in that organization 124 in accordance with various inventive aspects disclosed herein. System 100 includes one or more bots 112a-112n (collectively, bots 112), a dispatch controller 102, a processing and routing controller 104, and a task performance controller 106. In some inventive aspects, system 100 can optionally include an admin portal 114. At least one of dispatch controller 102, processing and routing controller 104, and task performance controller 106 stores and/or accesses processed and/or real-time data in one or more memory devices, such as memory/storage device 108. In various implementations, each of the bots 112, the admin portal 114, the dispatch controller 102, the processing and routing controller 104, and the task performance controller 106 are in digital communication with one another. One or more of the controllers (e.g., dispatch controller 102, processing and routing controller 104, task performance controller 106) similarly are in digital communication with the memory/storage device 108. In some implementations, at least one message bus is used to communicate between the dispatch controller, the processing and routing controller, and the task performance controller.

In some inventive implementations, the bots 112 function as an interface to system 100. One or more users in an organization, such as organization 124, can communicate with system 100 via a plurality of communication methodologies, referred to herein as “communication platforms,” or “providers” that interface with the bots. For instance, as shown in FIG. 11, a plurality of providers, for example, 116a-116c (collectively, providers 116) interface with the bots. Examples of such providers include, but are not limited to, a chat-client (e.g., Slack™ Hipchat®, Google Chat™, Microsoft Teams™ etc.), SMS, email, audio and/or video files, streaming audio and/or video data, customized web front-ends, and/or a combination thereof. Each provider can include a “communication channel” that links a bot to that provider. In some inventive aspects, a bot can obtain incoming messages from users in an organization via a communication channel included in a provider. In other words, a user can communicate with system 100 through a provider via a communication channel. System 100 obtains incoming messages and delivers outgoing messages via the bots.

In some inventive implementations of the system 100, the dispatch controller 102 can include a plurality of modules to process incoming messages. Each module in the plurality of modules can be dedicated to a particular provider. Incoming messages can be analyzed and processed by modules that correspond to the providers through which the incoming messages are obtained. For instance, an incoming message through provider A 116a shown in FIG. 11 may be analyzed by a first module within the dispatch controller. An incoming message through provider B 116b shown in FIG. 11 may be analyzed by a second module within the dispatch controller provided that provider A 116a and provider B 116b are different providers/communication platforms. The dispatch controller can convert incoming and outgoing messages between a standard format (e.g., used by the dispatch controller to communicate with other components described further below) and a format of an originating and/or intended communication platform/provider 116.

The processing and routing controller 104 of the system 100 shown in FIG. 11 interprets and routes converted incoming messages so as to appropriately execute one or more of a variety of skills/actions and/or obtain various types of information pursuant to the incoming messages. The processing and routing controller may include one or more processing components, referred to herein as “message attribute processing controller,” to add contextual information to the converted incoming message for further processing. The processing and routing controller further may include one or more routers, referred to herein as “augmented message router,” to determine the user intent underlying an incoming message and to route the message accordingly. In various aspects, the processing and routing controller executes machine learning techniques such as maximum entropy classification, Naive Bayes classification, a k-Nearest Neighbors (k-NN) clustering, Word2vec analysis, dependency tree analysis, n-gram analysis, hidden Markov analysis, probabilistic context-free grammar, and/or a combination thereof. The processing and routing controller further may include one or more compilers and/or high-level language interpreters, and may implement natural language processing techniques, data science models, and/or other learning techniques.

The task performance controller 106 of the system 100 shown in FIG. 11 generally implements action components, such as a set of core-skills/actions that may or may not be implemented in real-time. The core skills/actions may be implemented by the task performance controller via a web application development framework. The web application framework may be written in Ruby (i.e., a dynamic, reflective, object-oriented, general-purpose programming language).

In some implementations of the system 100 shown in FIG. 11, at least one memory or electronic storage device 108 is used to store real-time data (e.g., at least some of which may be organized in one or more databases) and/or processor-executable instructions to be accessed as necessary. Such a storage device may be in the form of a server (e.g., a cloud server such as Amazon Web Services™) to host data and/or processor-executable instructions used by the other controllers of the system 100.

In some implementations, an administrator of the organization 124 can interact with the system 100 via the admin portal 114.

### High-Level Overview of Example Architecture

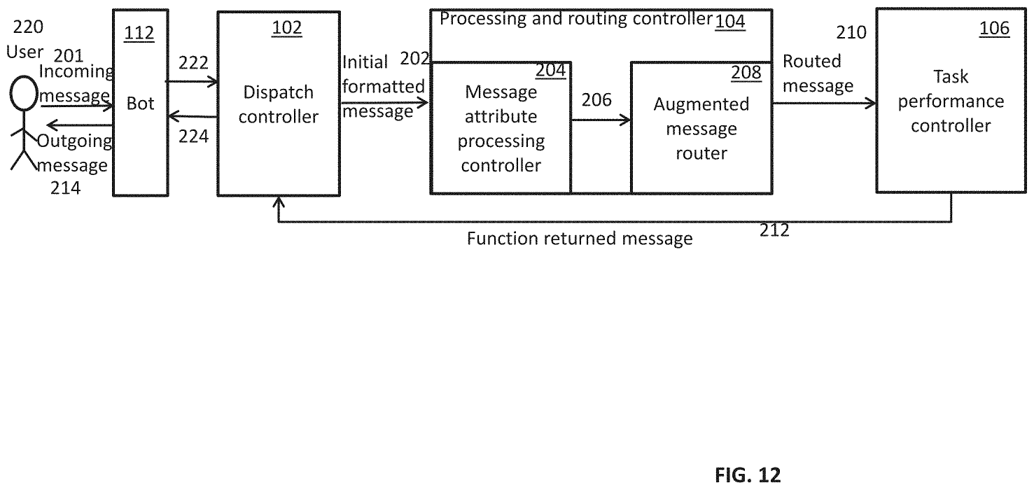

FIG. 12 illustrates a flow diagram depicting the high-level overview of processing an incoming message 201 from a user 220. According to some inventive aspects, system 100 may obtain an incoming message 201 from a user 220 to complete skills/actions. Bot 112 may obtain incoming message 201 through a provider (not shown) in natural language format. The provider may transform incoming message 201 that is in natural language format to a schema that is associated with the provider. That is, each provider may have a schema of its own. The provider may transform incoming message 201 to incoming schema message 222. Incoming schema message 222 is pushed from bot 112 to dispatch controller 102. Thus, incoming schema message 222 may be in a schema that is associated with the provider through which bot 112 has obtained the message.

Dispatch controller 102 may perform initial processing. Dispatch controller 102 may include one or more modules for processing incoming schema message 222. Each module in dispatch controller 102 may correspond to a particular communication platform/provider. Incoming schema message 222 may be pushed to the module that corresponds with the communication platform/provider through which the message was obtained. Processing incoming schema message 222 via dispatch controller 102 may include determining the identity of the user 220 and the communication platform/provider from which incoming message 201 is obtained. Dispatch controller 102 may resolve the identity of user 220 by matching user 220 to an internal profile within system 100. Internal profiles may be created by storing user identities of all users that may have previously interacted with system 100. Dispatch controller 102 may further associate incoming schema message 222 with a user identifier. Additionally, dispatch controller 102 may determine a platform/provider for communication of incoming message 201, determine the state of incoming message 201, associate a platform identifier based on the communication platform/provider determined, associate a message type identifier indicating the type of the message, provide other initial basic information for routing incoming schema message 222, and/or perform a combination there of. Further, dispatch controller 102 may package incoming schema message 222 into packets of metadata in a standard serialized format (e.g., a JSON string). In this manner, incoming message 201 may be fully normalized so that downstream components need not be concerned about which communication platform/provider was used to transmit incoming message 201, who user 220 is (i.e., user identity), and/or which account(s) are associated with the communication platform and/or user 220. Initial formatted message 202 (e.g., one or more packets of metadata) may then be sent to processing and routing controller 104 via an internal message bus.

Processing and routing controller 104 may be configured to interpret user-intent based on initial formatted message 202. In some inventive aspects, at least one message attribute processing controller 204 included in processing and routing controller 104 is configured to inspect and modify initial formatted message 202 for use by downstream components by identifying a specific feature associated with initial formatted message 202. Some examples of specific features include an intended recipient of incoming message 201 (e.g., a name assigned to system 100), a date and/or time associated with incoming message 201, a location associated with incoming message 201, and/or any other form of recurring pattern. In some inventive aspects, message attribute processing controller 204 implements one or more pattern matching algorithms (e.g., the Knuth-Morris-Pratt (KMP) string searching algorithm for finding occurrences of a word within a text string, regular expression (RE) pattern matching for identifying occurrences of a pattern of text, Rabin-Karp string searching algorithm for finding a pattern string using hashing, etc.) to identify any specific features. Message attribute processing controller 204 may then modify initial formatted message 202 by removing the identified specific feature (e.g., a string, word, pattern of text, etc.). The modified data may be repackaged into a container (e.g., hash maps, vectors, and dictionary) as a key-value pair. This augmented message 206 is sent from message attribute processing controller 204 to augmented message router 208.

In some inventive aspects, augmented message 206 is processed via at least one augmented message router 208 included in processing and routing controller 104. Each augmented message router 208 may process augmented message 206 upon receipt to match any incoming message 201 to a user-intent. In addition, each augmented message router 208 may also determine the probability of interpreting an incoming message 201 and executing the task associated with incoming message 201. Augmented message router 208 may employ machine learning techniques (e.g., maximum entropy classification, Naive Bayes classification, a k-Nearest Neighbors (k-NN) clustering, Word2vec analysis, dependency tree analysis, n-gram analysis, hidden Markov analysis, probabilistic context-free grammar, etc.) to classify and route augmented message 206. After augmented message 206 is processed and/or extracted by augmented message router 208, information may be saved in one or more memory devices, such as memory device 108. In some inventive aspects, one or more memory devices may provide parameters to enable the implementation of the machine learning techniques. In addition, processing and routing controller 104 may also implement a decision policy to determine which augmented message router 208 should transmit routed message 210 to task performance layer 106. Following processing and extraction by each augmented message router 208 and implementation of the decision policy by processing and routing controller 104, routed message 210 may be sent from processing and routing controller 104 to task performance layer 106 via an internal bus.

In some inventive aspects, processing and routing controller 104 may include machine learning models, machine learning techniques, natural language processing techniques, data science models, and/or other learning techniques. These techniques can be exposed to other components within system 100 and accessed by other components within system 100 via web service endpoints (e.g., HTTP endpoints). For instance, message attribute processing controller 204 and augmented message router 208 may access machine learning models and techniques via HTTP endpoints to process initial formatted message 202 and augmented message 206 respectively.

In some inventive aspects, routed message 210 is routed to an appropriate component within task performance controller 106. Task performance controller 106 may identify the task and/or domain from the routed message 210 and determine a function/method to be called. Task performance controller 106 may facilitate generation of an outgoing message 214 and/or execute the skill/action associated with the incoming message 201 by executing a function/method and by sending function returned message 212 to dispatch controller 102. In some inventive aspects, task performance layer 106 may access one or more learning techniques via web service endpoints to extract information from memory device 108 based at least in part on the identity of user 220 and the account associated with user 220. The extracted information may be used to configure a “personality” for outgoing response 214. Task performance controller 106 may include information associated with the “personality” in function returned message 212.

Dispatch controller 102 may reformat function returned message 212 from the standard serialized format to a schema that is associated with the appropriate provider/platform. Outgoing schema message 224 may be pushed to bot 112. The outgoing communication platform/provider may transform outgoing schema message 224 into natural language format. The reformatted outgoing message 214 may then be sent to user 220 via the chosen provider/communication platform.

### Bot

Bot 112 of system 100 shown in FIG. 11 functions as an interface to system 100. Bot 112 is an instance of an entry point into system 100. In some inventive aspects, bot 112 may be a computer program that may conduct a conversation with one or more users via auditory or textual methods. In some inventive aspects, system 100 provides, instantiates, and/or exposes one or more bots as an interface for a specific functionality. For instance, system 100 may instantiate a bot specifically for IT support within an organization. Similarly, system 100 may expose a bot specifically to respond to HR queries in an organization. In other instances, system 100 may instantiate the same bot as an interface for both IT support and to respond to HR queries. That is, in some instances, system 100 may instantiate the same bot as an interface for multiple functionalities. In this manner, the one or more bots can aid to/improve user experience for a user interacting with system 100.

In some inventive aspects, each organization may utilize one or more communication platforms/providers for users within the organization to communicate with system 100. Bot 112 may be provided, instantiated, and/or exposed depending upon the communication platform/provider. For example, in some aspects, a bot application may be installed into a provider environment (e.g., Slack™, Microsoft Teams™). In such aspects, bot 112 manifests depending on the provider. For example, once the bot application is installed the provider may assign a special user account to bot 112. Users can interact with this bot user and/or bot 112 by direct messaging, or sending an invitation to join, or communicating in public chat channels. In this manner, multiple bot users may be added to the same provider (e.g., by installing multiple bot applications). In other words, multiple bots 112 may be installed on the same provider. In other aspects, an interface within a provider environment (e.g., TallaChat™) may be dedicated entirely to system 100. In such aspects, the dedicated interface may function as bot 112 or one of more bots may be enabled or plugged in the provider environment to perform specific functions.

In some inventive aspects, a connection can be established between a provider and bot 112. In one instance, system 100 initiates this connection by obtaining credentials related to the provider. For example, in the case of Slack™, an OAuth 2.0 token may be obtained. This token grants bot 112 various permissions such as the ability to sign into Slack™ workspace and additional backend API tools for requesting user directory and historical data. A language specification such as SAML may be utilized to communicate the authentication information. In another instance, the communication platform/provider initiates the connection by sending a message to system 100. This establishes a communication channel between the provider and bot 112.

A user can send an incoming message to system 100 via bot 112 coupled to a communication channel in a communication platform/provider. Some non-limiting examples of the incoming message include a query, a response to a query previously sent to the user by system 100, and/or the like. For instance, the incoming message may be response to a poll that was previously initiated by bot 112. The incoming message can be in natural language format. The provider may then transform the incoming message into a schema that is associated with the provider. In doing so, the provider may add identification information into the schema. For instance, the provider may add information about the user, the type of message, the communication channel used for communication, and/or the like. That is, the provider can provide source metadata identifying an aspect of origin for the incoming message. The schema can include various other metadata, such as, timestamp data and/or the like. The transformed message in the provider schema (also referred to as “incoming schema message”) is pushed to dispatch controller 102 for further processing.

### Dispatch Controller (Incoming Message)

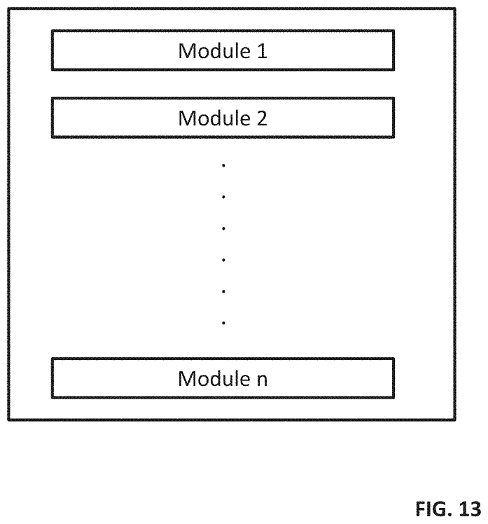

Dispatch controller 102 of system 100 shown in FIG. 11 is responsible for obtaining and performing initial processing of incoming schema messages (e.g., user-requests transformed to a provider schema) and for processing at least a part of outgoing communications to users. FIG. 13 illustrates dispatch controller 102 according to some inventive aspects. In some inventive aspects, this controller 102 may include one or more modules (e.g., module 1, module 2, . . . module n). Each module corresponds to a type of provider. For example, dispatch controller 102 can include a dedicated module for Slack™, another dedicated module for Microsoft Teams™, a different module for TallaChat™, and/or the like.

An incoming schema message is pushed to the appropriate module depending on the provider through which the incoming message was obtained. Each module performs initial processing of an incoming schema message by extracting identification information from the incoming schema message. Each module can then associate the incoming schema message with identifiers. That is, dispatch controller 102 may extract the identification information and associate the extracted information with identifiers. Dispatch controller 102 may access a memory, such as memory 108, to associate the incoming schema message with identifiers. For example, the incoming schema message may be modified to indicate or include an identifier representing organization identity (e.g., organization_id), user-identity (e.g., profile_id), source provider (e.g., provider_id), source communications channel (channel_id), source bot (e.g., bot_id) and/or the like.

In some inventive aspects, a unique identifier is assigned for every organization (e.g., organization_id) and is stored in the memory. Each user within an organization may be assigned a unique profile identifier (e.g., profile_id). In other words, if user A in an organization interacts with system 100 through provider A and through provider B, the messages obtained from both these providers are assigned the same internal profile identifier (e.g., profile_id).

In other aspects, the dispatch controller converts the incoming schema message from the format of the source platform to a standard serialized format (e.g., JSON). For instance, the incoming schema message from the provider may have the format of a JavaScript Object Notation (JSON) file or an eXtensible Markup Language (XML) file. Even the format of a JSON/XML file may be different for different providers. That is, for the same incoming message, data in a first JSON/XML file (e.g., a JSON string) from one provider may include different types of data, be organized according to a different syntax, and/or be encoded according to a different encoding scheme compared to data in a second JSON/XML file from another provider. Dispatch controller 102 converts each incoming schema message to a standard serialized format (e.g., a JSON format). In some inventive aspects, the standard format may include annotations indicating the source platform and/or the source format. Thus, in inventive aspects the dispatch controller 102 of the system 100 shown in FIG. 11 normalizes incoming messages from a user such that other components/controllers of the system 100 need not be concerned about platform-specific identities or accounts.

According to some inventive aspects, an example to illustrate the conversion of an incoming message from a source schema associated with a source platform/provider to a standard format is included below. The example illustrates conversion of an incoming message from Slack™ in the form of a JSON file to standard format JSON file. The example additionally illustrates the conversion of the same incoming message from HipChat™ in the form of XML, file to a standard format JSON file.

Slack™ (JSON)
{
″type″: ″message″,
″channel″: ″D0YFWV3LK″,
″user″: ″U0YFWLCSF″,
″text″: ″Hello System, how are you?″,
″ts″: ″1477657982.000014″,
″pinned_to″: null,
″team″: ″T0MQ5H5HC″
}
System standard (JSON)
{
“sender context”: {
“profile_id”: 1,
“organization_id”: 1,
“provider_id”: 1,
“account_uid”: “U0YFWLCSF”,
“channel_id” : “D0YFWV3LK”,
“bot_id”: 1,
“type” :0,
“public” : false,
“targeted” :0
},
“return route” : {
“uri” : “slack://127.0.0.1/45579947aa00b46ff59a2f19dc1442fa”
“context” : [
123,34,67,104,97,110,110,101,108,73,68,34,58,34,68,48,89,70,87,86,
51,76,75,34,44,34,85,115,101,114,73,68,34,58,34,85,48,89,70,87,76,67,
83,70,34,44,34,84,105,109,101,115,116
,97,109,112,34,58,34,34,125
]
},
“messages” : [{
“body” : “Hello system, how are you?”,
“interaction” : {
Domain” : “”,
“task” : “”,
“parameter” : null,
“actions” : [ ]
}
}],
...
}
HipChat™ (XML)
<message type=‘chat’ from=‘558221_3745966@chat.hipchat.com/
web||proxy|proxy-c409.hipchat.com|5282’ mid=‘c38ae89d-
6ee8-4fb7-bbbf-ee5b6a8236a2’
to=‘558221_3745526@chat.hipchat.com/bot||proxy|pubproxy-
c400.hipchat.com|5282’
ts=‘1477771520.708610’>
<body>Hello System, how are you?</body>
<x xmlns=‘http://hipchat.com/protocol/muc#room’>
<type/>
<notify>1</notify>
<message_Format>text</message_format>
</x>
<active xmlns=‘http://jabber.org/protocol/chatstates’/>
</message>
System standard (JSON)
{
“sender context”: {
“profile_id”: 1,
“organization_id”: 1,
“provider_id”: 3,
“account_uid”: “558221_3745966@chat.hipchat.com/web”,
“channel_id” : “558221_3745966@chat.hipchat.com/web”,
“bot_id”: 1,
“type” :0,
“public” : false,
“targeted” :0
},
“return route” : {
“uri” : “hipchat://127.0.0.1/20f8eacc702bb581d9b91c42d9b29c01”
“context” : [
123,34,82,101,109,111,116,101,73,68,34,58,34,53,53,56,50,50,49,95,
51,55,52,53,57,54,,64,99,104,97,116,46,104,105,112,99,104,97,116,46,
99,111,109,47,119,101,98,34,44,34,84,121,112,101,34,58,34,99,104,97,
116,34,125
]
},
“messages” : [{
“body” : “Hello system, how are you?”,
“interaction” : {
Domain” : “”,
“task” : “”,
“parameter” : null,
“actions” : [ ]
}
}],
...
}

In some inventive aspects, in the above example, ellipsis in the system standard JSON format include specific annotations related to the communication platform and/or the incoming message as described herein.

In some instances, the standard JSON format can include three parts. For example—

As illustrated in the example above, the first part indicates identification information, such as, the user, channel used for communication, bot used for communication, organization that the user belongs to, and/or the like. The second part indicates information for dispatch controller 102 to send a response back to the user, for example, the return route or return provider for the outgoing message. The second part also includes keys that reference identifier values in the memory. For example, keys that reference profile_id, organization_id, account_uid, bot_id, provider_id, and channel_id in the memory. The third part indicates the body of the message. This part also includes system-generated annotations, such as context clues that aid in resolving the context for the incoming message, and other generated data.

Thus, in inventive aspects the dispatch controller 102 of the system 100 shown in FIG. 11 normalizes incoming messages from a user such that other components/controllers of the system 100 need not be concerned about platform-specific identities or accounts. For example, if a single user interacts with system 100 across two communication platforms (e.g., a chat-client and an SMS service), dispatch controller 102 obtains incoming schema messages via one or more bots from either or both communication platforms, extracts identifiers associated with user identity and maps each of the incoming message to an internal profile of system 100. In some inventive aspects, system 100 may include a memory/storage device, such as memory 108, that stores user identities of all users that have previously interacted with system 100 as internal profiles of the users of system 100. As shown in FIG. 13, respective modules in dispatch controller 102 may resolve incoming schema messages from either or both communication platforms to a common internal profile associated with the user and provides the user with access to all of their internal data (including from both platforms) within system 100. In some inventive aspects, memory/storage device may include at least one mapping of incoming schema message associated with different providers/communication platform. That is, an incoming schema message format may be associated with a communications platform. Some non-limiting examples of communications platforms/providers are chat-clients, SMS, email, audio and/or video files, streaming audio and/or video data, Voice over IP (VoIP), videoconferencing, unified messaging, and customized web front-ends.

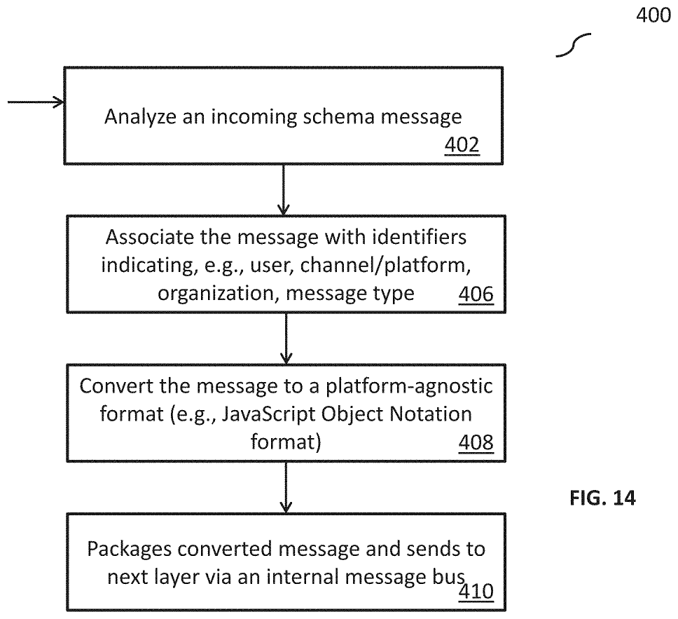

FIG. 14 is a flow diagram illustrating a method 400 for dispatching and/or processing an incoming schema message (incoming message that is transformed to the schema of the communication platform) in accordance with some inventive aspects. The system obtains (at a bot) an incoming schema message via a communication platform (e.g., chat-clients, SMS, email, customized web front-ends, VoIP, videoconferencing, unified messaging, etc.) and pushes the incoming schema message for further processing to the dispatch controller 102. At 402, system analyzes the incoming schema message. At 406, the dispatch controller 102 may associate the incoming message with identifiers indicating the user, platform through which the message was received and/or message type. In some inventive aspects, the system further associates the incoming message with basic information such as a response/outgoing message route designated for responding to the user or the organization to which the user belongs. At 408, the incoming schema message may be converted by the dispatch controller 102 to a platform-agnostic format or a standard serialized format as discussed above, thereby normalizing the message for use by downstream components (e.g., the processing and routing controller 104). Some examples of standard serialized format may include JavaScript Object Notation (JSON) format, etc. At 410, the converted message may be packaged into one or more packets of metadata (e.g., a JSON string) and the formatted message in the standard format is sent to the next controller (e.g., the processing and routing controller 104) via an internal message bus. Hence, the method 400 converts a platform-specific incoming message to platform agnostic standard-serialized formatted message.

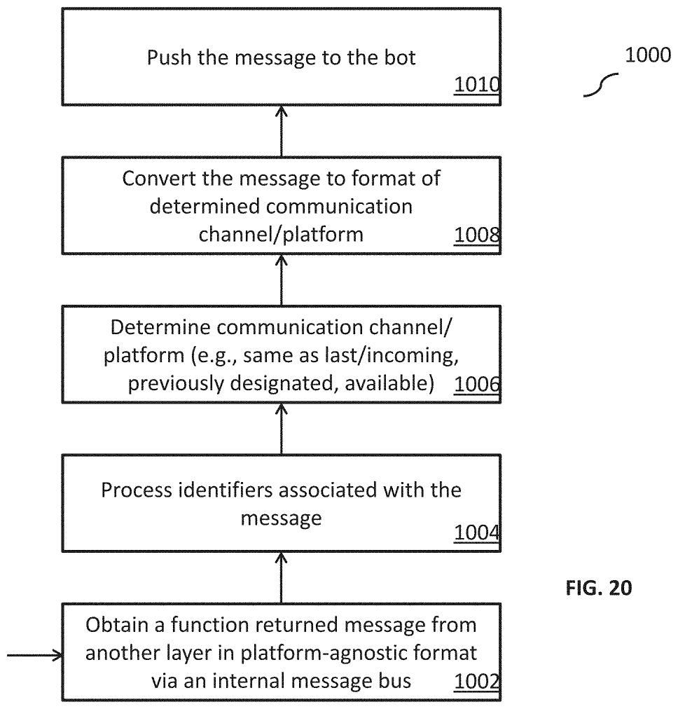

Dispatch controller 102 is further configured to process outgoing response messages that are obtained from other components/controllers of the system 100 and that represent feedback and/or content relating to the execution of one or more of a variety of skills/actions and/or various types of information pursuant to the incoming message. The method for dispatching an outgoing schema message is discussed further below and illustrated in FIG. 20 as disclosed herein.

### Processing and Routing Controller

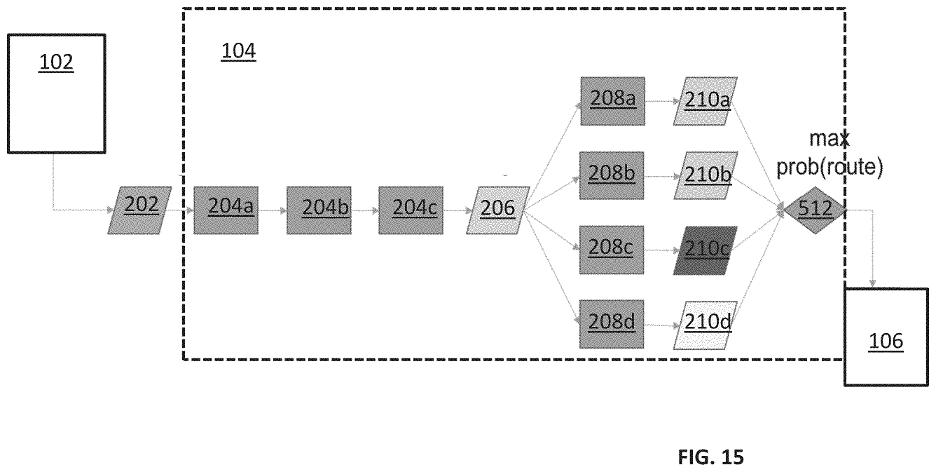

With reference to FIG. 15, in some inventive aspects, initial formatted message from dispatch controller 102 is sent to processing and routing controller 104 via an internal message bus of the system 100. The primary functionality of processing and routing controller 104 includes determining user intent from an incoming message, extracting any pertinent details to carry out the user intent, and providing any additional, contextual data.

In some inventive aspects, as discussed above, processing and routing controller 104 may include two modules as shown in FIG. 12 and FIG. 15. The first module (also referred to as “dispatcher module” herein) includes a series of message attribute processing controllers and a number of augmented message routers. The message attribute processing controllers analyze the formatted message and add further contextual information to the formatted message to create augmented messages. The augmented message routers then determine the user intent and route the augmented messages accordingly. The second module (also referred to as “server module” herein) includes various machine learning techniques such as maximum entropy classification, Naive Bayes classification, a k-Nearest Neighbors (k-NN) clustering, Word2vec analysis, dependency tree analysis, n-gram analysis, hidden Markov analysis, probabilistic context-free grammar, and/or a combination thereof. This server module may also include implementation of natural language processing techniques, data science models, and/or other learning techniques. The various machine learning models/techniques, natural language processing techniques, data science models, and other learning techniques may be exposed to the first module and the other controllers via one or more web service endpoints (e.g., HTTP endpoints). That is, the message attribute processing controllers or the augmented message routers may access various models and/or techniques included in the second module via HTTP endpoints to process the formatted message and/or the augmented message. In some inventive aspects, the message attribute processing controllers and augmented message routers may access portions of different models and/or techniques. In other inventive aspects, the message attribute processing controllers and augmented message routers may access an entire machine learning technique via a HTTP endpoint to process the messages further. In a similar manner, these models and/or techniques are also exposed to dispatch controller 102 and task controller 106 via web service endpoints.

FIG. 15 is a block diagram illustrating processing and routing controller 104 in accordance with some inventive aspects. Dispatch controller 102 may send standard formatted message 202 to processing and routing controller 104 via an internal message bus. In some inventive aspects, the processing and routing controller 104 includes at least one message attribute processing controller 204 for example a series of message attribute processing controllers 204a, 204b and 204c, for analyzing formatted message 202 that include identifiers that are associated with incoming message. The identifiers are associated by dispatch controller 102.

Message attribute processing controller 204 (e.g., a series or parallel sequence of message attribute processing controller) examines the natural language input in an incoming message, along with corresponding identifiers within initial formatted message 202, such as a user identifier indicating the user, a platform identifier indicating the communications platform or platform over which the incoming message was obtained, and/or a message type identifier indicating a type of incoming message. Message attribute processing controller 204 operates to mutate the initial formatted message by identifying patterns within the initial formatted message. Message attribute controller can then modify the initial formatted message to add further contextual information for more efficient processing. For example, a message attribute processing controller 204 may be configured to determine whether the incoming message is directed to a particular entity. If so, the message attribute processing controller 204 may modify the message to remove the information directing the incoming message to the particular entity and, instead, annotate initial formatted message 202 by associating initial formatted message 202 with an indication that the incoming message was directed to the particular entity (e.g., “True”). Other examples of patterns include, but are not limited to, the inclusion of date, time, and location information.

In some inventive aspects, a message attribute processing controller 204 may be a short program that inspects initial formatted message 202 to modify and annotate the message for more efficient use by downstream components. Some non-limiting examples of message attribute processing controllers include the following:
1) A “DebugMessage” processing controller detects if the message has the form “debug ‘message.’” This processing controller extracts the message part and annotates the data with the key-value pair message[“debug”]=True.
2) A “StopMessage” processing controller detects if the message includes any of a set of termination terms such as “stop,” “cancel,” “quit,” etc. This processing controller annotates the data with the key-value pair message[“stop_message’]=True.
3) A “ParameterProcessor” extracts parameter arguments from the message. For example, if the message contains a string that can be interpreted as a date or time then date and time are extracted as parameter arguments. If date and time are found, the relevant string is removed and datetime representations are added as message[“extracted_time_intents”]=times.

According to some inventive aspects, an example code for message attribute processing controllers is included below.

```
import json
import logging
import re
import yaml
from magic.data.models import ScriptStates, Bots
from magic.extractor import TimeIntentExtractor, Extractor
from magic.models.sentiment.vader import VaderSentimentAnalyzer
class DebugMessage(object):
  def process(self, profile, message):
    # try to extract a message in the form: debug “some command”
    match = re.match(“\hat{ }debug\s+\”(.*)\“”, message[“body”])
    if match:
    message[“debug”] = True
    message[“body”] = match.group(1)
    return message
class StopMessage(object):
  def process(self, profile, message):
    stop_regex = “\hat{ }(stop\never\s?mind\abort\cancel\quit\forget\s+it)\\b”
    match = re.match(stop_regex, message[“body”], re.IGNORECASE)
    if match:
      message[“stop_message”] = True
      message[“stop_text”] = match.group(1)
    return message
class QuestionMessage(object):
  “““
  Annotates a message specifying whether it is suspected of being a
  question or not, used by some routers. For the time being, simply
  checks for a question mark, though in the future should use some
  more sophisticated
  method.
  ”””
  def process(self, profile, message):
    question_regex = “.*\?[\W\!]*$”
    match = re.match(question_regex, message[“body”],
    re.IGNORECASE)
    if match:
      message[“is_question”] = True
    return message
class HelpMessage(object):
  def process(self, profile, message):
    help_regex = “\hat{ }(help)\\b”
    match = re.match(help_regex, message[“body”], re.IGNORECASE)
    if match:
      message[“help_message”] = True
      message[“help_text”] = match.string
    return message
class NLIDBMessage(object):
  def process(self, profile, message):
    if message[‘body’][:5] == ‘nlidb’:
      message[‘body’] = message[‘body’][6:]
      message[‘enable_nlidb’] = True
    return message
class RecommenderMessage(object):
  def process(self, profile, message):
    if message[‘body’][:9] == ‘recommend’:
      message[‘body’] = message[‘body’][10:]
      message[‘is_expert_request’] = True
    return message
class DateProcessor(object):
  “““
  Parses any dates out of the body and annotates as ‘extracted_dates’.
  ”””
  def process(self, profile, message):
    # all these values could be populated upstream.
    # in fact profile_id and organization_id already are.
    ctx = {
      ‘profile_id’: profile.id,
      ‘organization_id’: profile.organization,
      ‘timezone’: profile.timezone
    }
    body, times = TimeIntentExtractor.extract(ctx, message,
                            message[“body”], { })
    message[“extracted_time_intents”] = times if times is not None
    else [ ]
    return message
class ParameterProcessor(object):
  def_init_(self):
    with open(‘data/extractions.json’) as fh:
      self.extractions = json.load(fh)
  def process(self, profile, message):
    “““
    Extracts parameters for the current task.
    ”””
  (domain, task) = self._current_task(message)
  message[‘new_parameters’] = self.extract_params(profile, message,
                        domain, task)
  return message
def extract _params(self, profile, message, domain, task):
  extractor = Extractor(None, None)
  if profile is not None:
    extractor = Extractor(profile.id, profile.organization,
            profile.timezone)
  key = “{ }.{ }”.format(domain, task)
  extractions = self.extractions.get(key, None)
  parameters = message.get(‘parameters’, { })
  if extractions is not None:
    # Start with any previous parameters, for example, those that get
    # regex matched.
    for k, v in parameters.copy( ).items( ):
      results = extractor.extract(message, v, {k: extractions[k]},
                          True)
      valid = k in extractions and k in results
      if not valid:
        del parameters[k]
    results = extractor.extract(message, message[‘body’], extractions)
    for k, v in results.items( ):
      parameters[k] = v
  return parameters
def_script_state(self, message):
  profile = message[“sender_context”][“profile_id”]
  return ScriptStates.get(ScriptStates.profile == profile)
def_current_task(self, message):
  “““
  Returns a tuple containing the domain & task for the current task,
  assuming that
  ”””
  try:
    script_state = self._script_state(message)
    (domain, task) = script_state.script_name.split(‘.’)
      context = yaml.load(script_state.serialized_context)
      if context is not None and ‘skill’ in context:
        # some tasks execute on behalf of other skills...
        (domain, task) = context[‘skill’].split(‘.’)
      logging.info(“Current task: { }.{ }”.format(domain, task))
      return domain, task
    except Exception as e:
      logging.warning(“Could not find current task: { }”.format(e))
      # no script state means no task running
      return None, None
class SentimentProcessor(object):
  “““
  Detects sentiment(neg/pos/neu) of the message and annotates
  as ‘sentiment’.
  ”””
  def_init_(self):
    self.sa = VaderSentimentAnalyzer( )
  def process(self, profile, message):
    sentiment = self.sa.prob_classify(message[‘body’])
    message[“sentiment”] = sentiment.max( )
    return message
```

In FIG. 15, a series of message attribute processing controllers 204 is used to analyze the JSON string data/initial formatted message 202 to identify specific features. In some inventive aspects, processing and routing controller 104 includes at least one message attribute processing controller, such as, for example, a parallel sequence of message attribute processing controllers and/or a serial sequence of message attribute processing controllers (e.g., message attribute processing controllers 204a, 204b, and 204c) which can identify at least one specific feature. Message attribute processing controllers 204 may modify initial formatted message 202 based on any specific features determined during processing.

In FIG. 15, modified/augmented message 206 is sent from the message attribute processing controllers 204 to a sequence of augmented message routers 208. In some inventive aspects, processing and routing controller 104 includes at least one augmented message router, such as, for example, a serial sequence of augmented message routers and/or a parallel sequence of augmented message routers (e.g., routers 208a, 208b, 208c, and 208d). Augmented message routers 208 may be responsible for routing the message to task performance controller 106 as an annotated block of data by extracting relevant information from augmented message 206.

In some inventive aspects, modified/augmented message 206 is sent to each augmented message router in the sequence of augmented message routers 208. The modified/augmented message 206 can be sent to each augmented message router in the sequence of augmented message routers in any order. Each augmented message router processes the augmented message and matches the augmented message to one or more domains and/or tasks. In some aspects, a domain may be a broad collection of skills and a task may be a specific action (e.g., Domain: QuestionIdentification, Task: unknown_question). Some augmented message routers may match augmented message 206 against a large range of domains and/or tasks while other augmented message routers may match augmented message 206 to a specific domain and/or task. Each augmented message router then determines the user intent based on this matching. In other words, each augmented message router processes augmented message 206 and determines a user intent for the message. That is, two augmented message routers may determine two different user intents for the same augmented message. The logical effect of this implementation of passing an augmented message through every augmented message router in a sequence of augmented message routers (in series or in parallel) is that the augmented message is processed in parallel.

In some inventive aspects, each augmented message router can access the same models and/or techniques included in the second module of processing and routing controller 106. For example, two augmented message routers may access two out of three of the same models and/or techniques. However, each of the two augmented message routers may access a different model and/or technique as a third model and/or technique.

In some inventive aspects, an augmented message router takes a processed message payload/augmented message 206 and attempts to match it to user intent (e.g., domain, task). An augmented router may contribute further annotations to augmented message 206 to indicate domain, task, and/or other extracted parameters to be used by task performance controller 106 while executing the skill. Some augmented message routers may attempt to match against a large range of domains and/or tasks, while others may only detect a particular domain or task. Some non-limiting examples of augmented message routers include the following:
1) “RegexRouter” detects if the message exactly matches a predefined pattern using regular expressions. These patterns may be automatically generated from a list of example statements per skill. Arguments needed by the detected skill may also be extracted using the regular expressions. In some inventive aspects, these augmented message routers may contain a file or database that saves extracted information. The file or database may include a list of regular expressions and corresponding skills. With every iteration, if a new skill is identified, the regular expression and the new skill are stored in the file. The file is parsed during runtime to identify the intent based on the expression.
2) “TextblobRouter” classifies the message as a known skill using a classifier such as a trained maximum entropy classifier. The classifier may be trained from a file or database including a list of example statements and corresponding skills. This may be the same file used to generate regular expressions. Arguments needed by a detected skill may be extracted using a set of relevant extractor methods including, for example, methods for strings, numerics, datetimes, URLs, people names, etc. These extractor methods may be based on one or more algorithms, including regular expressions and other machine learning tools, depending on the item to be extracted. For example, some extractors may identify items of information relating to the time that the message was sent or the title of the message. These items of information may then be stored in a file or database and accessed to obtain parameters while implementing machine learning techniques.
3) “SocialGracesRouter” detects if the message is a common social utterance, such as “hi,” “hello,” “thanks,” etc.
4) “QuestionRouter” detects if the message is a question. If it is a questions, this router may attempt to classify the question as one of several known questions stored in a file or database in order to identify a known answer. In some inventive aspects, the classification method is a hybrid model based on one or more algorithms such as Naive Bayes classification, sentence embedding, and k-NN classification. A Naive Bayes classifier may match a question based on a level of occurrence and co-occurrence of one or more key words. Sentence embedding may convert each word in a sentence into a numeric vector representation of that word; then the vectors of each word in the sentence are averaged for a single numeric vector representing the entire sentence. A k-NN classifier may match an average numeric vector resulting from sentence embedding of an input message with known average numeric vectors resulting from sentence embeddings of canonical questions by, for example, the average label of the k-closest samples to the input (using cosine similarity for a distance metric).

According to some inventive aspects, an example code for a default augmented message router is included below—

```
from .router import Router
class DefaultRouter(Router):
  def _init_(self):
    super(DefaultRouter, self)._init_( )
  def route(self, profile, message):
    if not ‘domain’ in message or not ‘task’ in message:
      message[‘domain’] = ‘Default’
      message[‘task’] = ‘unrouted_message’
      message[‘probability’] = 0.0
    return message
```

According to some inventive aspects, an example code for a “SocialGracesRouter” augmented message router is included below—

```
import csv
import pickle
import os
import re
import logging
from .router import Router
from .utils import normalize, train_max_ent, null_questions
import magic
dataset_path = ‘benchmark/social-graces.csv’
cached_path = (os.path.dirname(os.path.realpath(_file_)) +
            “/../../data/cached_social_graces_classifier.pickle”)
def default_data_set( ):
  f = csv.reader(open(dataset_path))
  return list(map(
    lambda y: (y[0].lower( ), y[1] + ‘.’ + y[2]), [i for i in f]))
def social_graces_classifier( ):
  logging.info(“Loading cached classifier...”)
  return pickle.load(open(cached_path, ‘rb’))
# Router for social graces such as salutations, benedictions.
class SocialGracesRouter(Router):
  def _init_(self, classifier = None):
    super(SocialGracesRouter, self)._init_( )
    self.classifier = classifier
    if self.classifier is None:
      self.classifier = social_graces_classifier( )
  def train(self):
    logging.info(“Training new classifier...”)
    classifier = train_max_ent(default_data_set( ) + null_questions( ))
    pickle.dump(classifier, open(cached_path, ‘wb’))
  def route(self, profile, message):
    result = self.classifier.prob_classify(normalize(message[‘body’]))
    if (result.prob(result.max( )) > 0.80 or ‘debug’ in message) and
re.match(“\hat{ }NULL-”, result.max( )) is None:
      (domain, task) = result.max( ).split(‘.’)
      message[‘domain’] = domain
      message[‘task’] = task
      # clamp probability lower to give priority to functional skills
      # and not trigger “override” behaviors
      message[‘probability’] =
min(magic.SOCIAL_PROBABILITY_CLAMP_VALUE,
result.prob(result.max( )))
      return message
    return None
```

According to some inventive aspects, an example code for a “QuestionRouter” augmented message router is included below—

```
import sys
import os
import logging
import pickle
import json
import peewee
from .router import Router
from .feature_extractor import features
import magic.models.manager
import magic.models.qa as qa
import magic.models.qa.filters as filters
from magic.extractor import Extractor
from magic.models.qarecommender import QARecommenderBuilder
from collections import namedtuple
from magic.data.models import QuestionTexts, CanonicalQuestions, fn, database
from playhouse.postgres_ext import Match
from datetime import datetime
QAResult = namedtuple(‘QAResult’, [‘probability’, ‘cqid’, ‘qtid’])
class QuestionRouter(Router):
  # queue - queue for inline training of models
  def _init_(self, queue):
    super(QuestionRouter, self)._init_( )
    self.training_queue = queue
  def route(self, profile, message):
    if message[‘body’] == “ or not Router.enabled_for_bot(self.bot(message).bot_type,
“QuestionIdentification”):
      return None
    # Having arrived here with the belief that this is a question of
    # some kind, we can start with the classification of unknown_question,
    # which will be updated below if a specific question matches.
    message[‘probability’] = magic.QA_PROBABILITY_CLAMP_VALUE
    message[‘domain’] = ‘QuestionIdentification’
    message[‘task’] = ‘unknown_question’
    message[‘parameters’] = {‘qa_model_version’: str(qa.MODEL_VERSION)}
    bot_id = message[‘sender_context’][‘bot_id’]
    message = self.route_with_classifier_builder(profile, message,
qa.QuestionClassifierBuilder(bot_id, self.training_queue))
    if message[‘task’] == ‘unknown_question’:
      # try again with global scope
      message = self.route_with_classifier_builder(profile, message,
qa.QuestionClassifierBuilder(None, self.training_queue))
    return message
  def route_with_classifier_builder(self, profile, message, builder):
    suggestions = [ ]
    prob = 0.0
    #Want to move to the below:
    #classifier, cache_version = builder.fetch_classifier( )
    classifier, stale, cache_version = builder.fetch_classifier( )
    if classifier is None:
      logging.info(“NO CLASSIFIER FOUND, SKIPPING for bot_id
{ }”.format(builder.bot_id))
      return message
    suggestions = filters.filter_questions(
      filters.canonical_questions(builder.bot_id),
[filters.is_not_null_question.filters.minimum_confidence_threshold(magic.
QA_MINIMUM_CONFIDENCE_THRESHOLD)],
      classifier,
      message [‘body’],
    )
    if stale:
      cache_time = datetime.fromtimestamp(int(cache_version.split(‘-’)[0]))
      search_results = QuestionTexts.select( ) \
        .join(CanonicalQuestions, on=(CanonicalQuestions.id ==
QuestionTexts.canonical_question)) \
        .where(
          (QuestionTexts.created_at > cache_time) &
          (CanonicalQuestions.bot == builder.bot_id) &
          Match(QuestionTexts.text, peewee.SQL(“%s”,
“‘{ }’”.format(message[‘body’].replace(“‘”, “ ”))))
        )
      suggestions += [QAResult(cqid=result.canonical_question, qtid=result.id,
probability=magic.QA_PROBABILITY_THRESHOLD) for result in search_results]
    if ‘debug’ in message:
      # If debugging, populate the max even if we don't end up
      # resolving to an answer.
      message[‘probability’] = prob
      message[‘parameters’] = {“canonical_question_ids”: [x.cqid for x in
suggestions]}
    for found in suggestions:
      logging.info(“qa match found ({ }): { }”.format(found.cqid, found.probability))
    logging.info(“number of qa matches after filtering: { }”.format(len(suggestions)))
    if len(suggestions) > 0:
      prob = suggestions[0].probability
    if prob >= magic.QA_PROBABILITY_THRESHOLD:
      if len(suggestions) > 0:
        message[‘task’] = ‘suggest_questions’
      message[‘parameters’] = {
        ‘qa_model_version’: str(qa.MODEL_VERSION),
        ‘answers’: [{‘probability’: i.probability, ‘canonical_question_id’: i.cqid,
              ‘question_text_id’: i.qtid} for i in suggestions],
      }
      # clamp probability lower to give priority to functional skills
      # and not trigger “override” behaviors
      message[‘probability’] = min(prob, magic.QA_PROBABILITY_CLAMP_VALUE)
    recommender = QARecommenderBuilder(message[‘sender_context’][‘bot_id’],
self.training_queue).fetch_model( )
    if recommender is not None:
      message[‘recommended_profile_ids’] = [i for i in
recommender.profile_recommendations(message[‘body’]) if i[0] is not None]
      message[‘recommended_tags’] = [i for i in
recommender.tag_recommendations(message[‘body’]) if i[0] is not None]
      logging.info(“QA: adding profile IDs and tags ({ },
{ })”.format(message[‘recommended_profile_ids’], message[‘recommended_tags’]))
    return message
```

In some inventive aspects, the domain-specific functionality of augmented message routers may include, but are not limited to, knowledge-based and question-and-answer routing, natural language routing, and routing to invoke tasks and/or workflows. Augmented message routers that function within a domain of invoking tasks and/or workflows may resolve incoming messages by invoking specific tasks. For example, the incoming message “schedule a meeting with Bob and Sally” may be invoked in this domain. Augmented message routers that function within a domain of natural language resolve incoming messages by locating saved resources (e.g., a file or database in memory) and generating an appropriate query based on the natural language input. For example, the incoming message “how many users signed up yesterday?” may be invoked in this domain. Knowledge-base/question-and-answer routers may resolve incoming messages to specific entries in a preexisting knowledge base (e.g., a file or database in memory). For example, the incoming message “where do I find the company calendar” may be invoked in this domain.

In FIG. 15, the routed (and annotated) messages 210 from each router including, for example, routed messages 210a, 210b, 210c, and 210d, are routed by the corresponding routers, 208a, 208b, 208c, and 208d respectively. These routed messages 210 may include or be further analyzed to determine corresponding probabilities of correctly interpreting the incoming message and determining the user intent. In some inventive aspects, each router determines a probability score. A decision policy may be implemented to determine a winning augmented message router. The output of the winning augmented message router (i.e., routed message (210a, 210b, 210c, or 210d) from the winning augmented message router) is considered in 512. The routed message may include the domain and/or task determined by the winning augmented message router in standard serialized format. In some inventive aspects, the routed message with the highest probability score is considered in 512. For instance, if the probability score of routed message 210c from router 208c is the highest probability score and/or meets a predetermined threshold for probability scores, then message 210c is considered. Fully annotated routed message 210c is then sent to task performance controller 106 via the internal message bus.

An important functionality of processing and routing controller is Natural Language Understanding (NLU)—from a natural language utterance. Processing and routing controller 104 determines the user intent, extracts any pertinent details to carry out the intent, and provides any additional, relevant contextual data. After useful data is harvested from a natural language utterance and user intent is determined, processing and routing controller 104 may send harvested data and user intent to task processing controller 106 to execute the user intent.

In some inventive aspects, at least one message attribute processing controller (e.g., a series or parallel sequence of message attribute processing controllers) processes and modifies the initial formatted message. The modification is performed to extract valuable information from the initial formatted message. For example, an incoming message may be directed to the system (e.g., a name associated with the system) and the incoming message may include the term “@ system” in the message. A dispatch controller may format the message and process the message by associating identifiers (e.g., user identity, communication platform from which the message is obtained, etc.) with the incoming message. The formatted initial message may then be sent to a processing and routing controller including at least one message attribute processing controller. In some inventive aspects, the initial formatted message is sent through each message attribute processing controller, and each message attribute processing controller may further modify the message appropriately. For example, a message attribute processing controller handling “@system” requests, may process the message to remove the “@system” term and retain only the body of the message. This or another message attribute processing controller further may perform pattern matching and send annotated data with key-value pair/augmented message to at least one augmented message router for routing.

In some inventive aspects, the formatted initial message may be sent to at least one message attribute processing controller (e.g., a series or parallel sequence of message attribute processing controllers). Each message processing controller may analyze the message but not may leave the formatted initial message unchanged. For example, if an identifier corresponding to at least one of the message attribute processing controller is not present in the formatted initial message, the formatted initial message may not be modified. In such inventive aspects, the formatted initial message is transmitted to at least one augmented message router for further processing. In other words, although the formatted initial message passes through a series or a parallel sequence of message processing controllers, it is possible that the formatted initial message may remain unchanged until it reaches an augmented message router.

In some inventive aspects, at least one augmented message router is responsible for routing the augmented message to an appropriate task performance controller component by extracting relevant information from the augmented message and routing the message as an annotated block of data. Each augmented message router may be domain specific and/or function specific. The augmented message obtained at each router may be further processed by the augmented message router provided that the augmented message is within the domain of that specific router. In some inventive aspects, the augmented message is sent through each augmented message router. If an augmented message router does not respond to the message, then the augmented message router does not return any data. As the augmented message is further processed by the augmented message routers, the data is further annotated and the extracted information may be saved in a memory device/storage. An augmented message router may access machine learning techniques via HTTP endpoints to classify and route the data. Some non-limiting examples of machine learning techniques employed in processing and routing controller 106 are maximum entropy classification, Naive Bayes classification, a k-Nearest Neighbors (k-NN) clustering, Word2vec analysis, dependency tree analysis, n-gram analysis, hidden Markov analysis and probabilistic context-free grammar. In some inventive aspects, a memory device/storage may provide parameters for the machine learning algorithms from saved information/data. The probability score of a fully annotated routed message from each router may be analyzed, and a decision policy may be implemented to send the routed message to a task performance controller. In some inventive aspects, the decision policy may include comparing the probability score of the fully annotated message from each router and determining at least one domain and/or task based on the comparison to send the routed message to the task performance controller. In some inventive aspects, the decision policy may include comparing contextual information in the augmented message. That is, the decision policy may include comparing information that is external to the augmented message routers. The message processing controllers may add contextual information such as recent message history, time of day, provider through which the message was obtained, the user generating the information, and/or the like to the augmented message. The decision policy may include comparing this contextual information to route the message to the task performance controller.

According to some inventive aspects, pseudocode for a processing and routing controller or (e.g., the routine which runs an incoming message through a progression of processors to mutate and annotate the message followed by a progression of routers, from which the highest probability response is selected as the action to take) includes the following:

```
routine main( ):
processors = [Processor1, Processor2, ...]
routers = [Router1, Router2, Router3, Router4, ...]
dispatcher = Dispatcher(processors, routers)
on new message:
    dispatcher.dispatch(message)
routine dispatch(message):
    for each processor in processors:
        message = processor.process(message)
responses = new list
    for each router in routers:
        response = router.route(message)
        if response is valid:
            append response to responses
best_response = response in responses with highest probability
send message to best_response endpoint with a return route
```

According to some inventive aspects, message data includes the following:

```
message =
{
    body: “add task to complete documentation due at 4pm”,
    profile_id: 12345,
    debug: false,
    domain: “Tasks”,
    task: “create_task”,
    probability: 0.99,
    parameters: {title: “complete documentation”,
    due: (2016, 09, 15, 16, 0)}
}
```

Processing and routing controller 104 may be configured further to store relevant information in/readily access any information from one or more memory devices, such as memory device 108.

In some inventive aspects, once the user intent is determined, multiple entities may be extracted from the message to serve as tags for the routed message. The result of extraction by the processing and routing controller 104 may be a message associated and/or tagged with a “domain,” “task,” “parameters,” another indicator, and/or a combination thereof. For example, the incoming message “schedule a meeting with Bob and Sally” may be classified as a “schedule_meeting” command, which may have various parameters, such as “attendee,” “location,” “date,” and “time.” The incoming message is then processed to automatically extract parameters present in the incoming message. For example, the names “Bob” and “Sally” ‘may be automatically recognized as names (e.g., in the user's organization) and associated with the “attendee” parameter in the “schedule_meeting” command.

Processing and routing controller 104 may be configured further to store relevant information in/readily access any information from one or more memory devices, such as memory device 108. In some inventive aspects, in addition to routing incoming messages, processing and routing controller 104 also may be configured to generate an outgoing message or response to the user following incoming message routing and/or task performance (e.g., performed by task performance controller 106). In some inventive aspects, one or more formats for responses are hardcoded. In other inventive aspects, the format of a response is processed dynamically and is given a “personality” using natural language generation. Processing and routing controller 104 may determine a personality intelligently based on, for example, the incoming message to which it is responding. For example, if an incoming message begins with a formal greeting, the outgoing message may be generated to begin with a formal greeting as well.

In this manner, processing and routing controller 106 is designed to add and/or remove specific functionalities in a granular manner. That is, the modular design for implementing message attribute processing controllers and augmented message routers makes system 100 scalable without impacting the scope of system 100. For example, to remove the functionality of invoking workflows, only the augmented message router implementing the domain that invokes tasks needs to be modified. Such modification is on a granular level and does not impact the scope of the entire system 100. Thus, the architecture of system 100 can be maintained while expanding its functionality and scaling it.

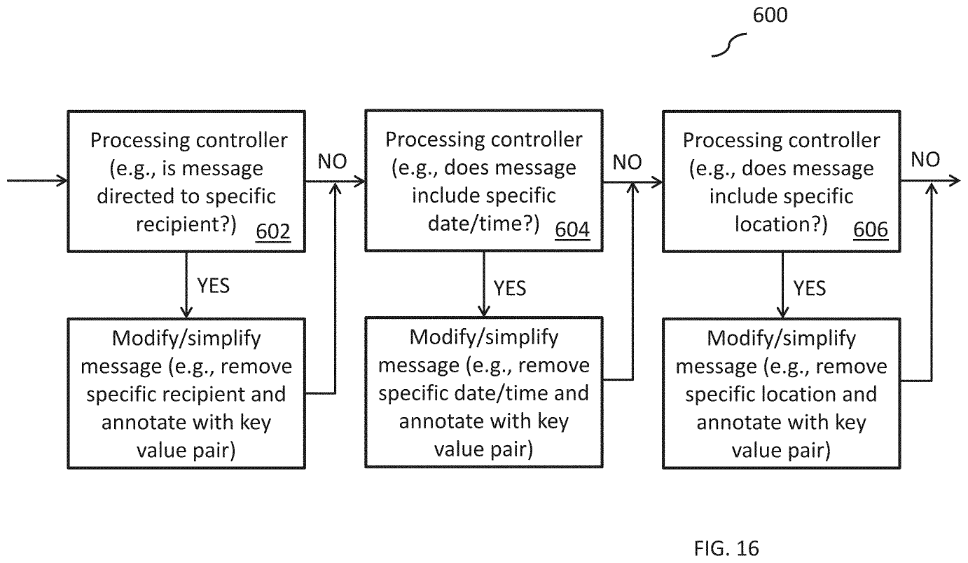

FIG. 16 is a flow diagram illustrating operation of a series of message attribute processing controllers in accordance with some inventive aspects. A processing and routing controller may include a series of message attribute processing controllers to process and modify initial formatted message. In some inventive aspects, each message attribute processing controller recognizes one specific feature. If the incoming message contains that specific feature, the message attribute processing controllers may modify the initial formatted message by removing the identifier associated with that particular specific feature. The message attribute processing controllers may then package the modified message (e.g., augmented message) as key-value pairs that indicate the identifier/associated specific feature. However, if the incoming message does not contain that specific feature the initial formatted message may be sent to the next processor for processing.

In method 600 of FIG. 16, message attribute processing controller 602 obtains the initial formatted message from a dispatch controller. Message attribute processing controller 602 recognizes specific recipients associated with the incoming message. For example, if the incoming message is addressed specifically to the system and contains “@system,” message attribute processing controller 602 recognizes this feature. Message attribute processing controller 602 may then modify the initial formatted message by removing “@system” and annotating with key-value pair (e.g., message[“@system”]=True). In some inventive aspects, the key-value pairs may be stored in containers such as hash-maps, dictionaries, and/or vectors. However, if the incoming message is not addressed or does not contain the specific recipient feature, then the initial formatted message is sent to message attribute processing controller 604 without modification. Message attribute processing controller 604 recognizes data/time information within the incoming message. If this specific feature is not present in the incoming message, the initial formatted message is then sent to the message attribute processing controller 606 for further processing (e.g., recognition of location information). In this manner, the formatted message is dispatched through each of the processor and is modified according to the features/patterns.

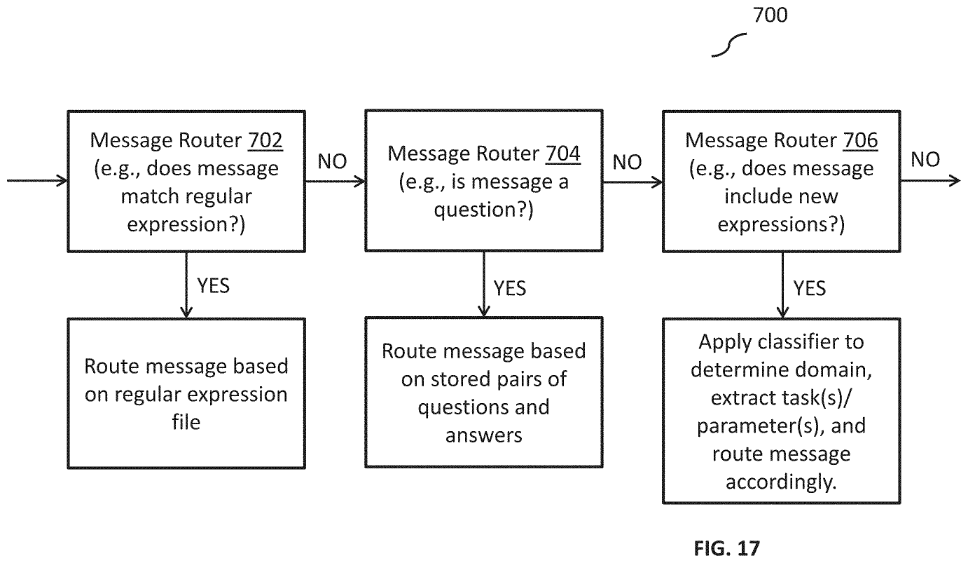

FIG. 17 is a flow diagram illustrating operation of a sequence of augmented message routers in accordance with some inventive aspects. In some inventive aspects, the sequence of augmented message routers is responsible for routing the data to an appropriate component by extracting relevant information. Each augmented message router may be domain specific and/or function specific. The augmented message/annotated and processed message from the at least one message attribute processing controller is sent to the sequence of augmented message routers. At each augmented message router, the augmented message may be further processed by the augmented message router provided that the message is within the domain of that specific router. In one inventive aspect, the augmented message is sent through each augmented message router sequentially. If an augmented message router does not respond to the augmented message, no data is returned. If the augmented message is within the domain and/or the function of the augmented message router, the augmented message router may respond by further processing the message and routing the message accordingly.

In method 700 of FIG. 17, an augmented message is first sent through a regular expressions router 702. If the augmented message exactly matches a predefined pattern using regular expressions, then the message is processed and routed via regular expressions message router 702. The regular expressions message router may include a file that saves extracted information that is parsed during runtime. This file may be updated dynamically or periodically.

If the augmented message does not match a predefined pattern, the augmented message is sent to a question-and-answer message router 704. Question-and-answer message router 704 detects if the message is a question (e.g., determines whether a question mark is used). If the message appears to be a question, then question-and-answer message router 704 may attempt to classify the question as one of several known questions stored in memory (e.g., a file or database) in order to determine the corresponding answer. The augmented message may be routed based on stored pairs of questions and answers.

If the augmented message is not recognized as a question, the message is sent to a natural language message router 706 that attempts to interpret new expressions. If the message includes new expressions, augmented message router 706 may process the data by applying a classifier to determine domain and to extract tasks. The processed data/routed message may be routed appropriately via message router 706. If the message does not include new expressions, the augmented message may be sent to another augmented message router within the sequence. In this manner, the augmented message is processed and routed sequentially. Alternatively, for example, if none of the augmented message routers are successful, a response may be sent to the user via the dispatch controller requesting more information for routing purposes.

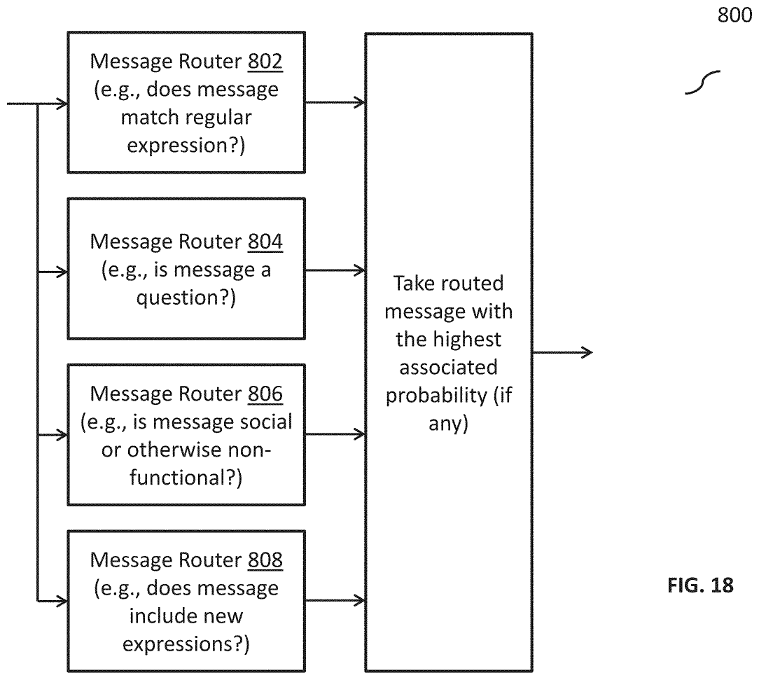

FIG. 18 is a flow diagram illustrating parallel operation of augmented message routers in accordance with some inventive aspects. In method 800, a processed message sent through multiple augmented message routers 802, 804, 806, and 808 in parallel (e.g., simultaneously). If the augmented message is not within the domain/function of an augmented message router, the augmented message router does not return any data. However, if the augmented message falls within the domain of an augmented message router, the augmented message router processes the message and returns a router-specific copy of the message including, for example, a probability score indicating the likelihood that the augmented message router accurately determined a task for the router-specific copy of the message. A decision policy may then be implemented to determine which router-specific copy of the message may be sent to another controller for task completion and/or generation of an appropriate response to be sent to the user.

### Task Processing Controller

Task performance controller 106 of the system 100 shown in FIG. 11 is communicatively coupled to the processing and routing controller 104 and, in turn, may be further coupled to dispatch controller 102. In some inventive aspects, task performance controller 106 includes different modules of skills/actions. In some instances, the modules of skills/actions that are included in task processing controller 106 depend on what a user can do via a particular bot. For instance, if a user communicates via a bot of a specific type with a functionality that is independent of the organization, then in some such cases, the incoming message may be directly routed from the message attribute processing controller and/or dispatch controller 102 to task processing controller 106. For example, if a user is communicating with a FAQ bot that has only FAQ interaction functionality, the augmented message router will not return a response if the communication is about invoking a workflow since the FAQ bot does not support this functionality. In other instances, if the bot has a functionality that is scoped at the organization level (e.g., Company X′s FAQ bot no longer responds to questions due to a trial period ending), in such instances the skills/actions may be handled either at the augmented message router or at task processing controller 106 depending on the nature of the functionality scoping.

In some inventive aspects, routed message is sent from processing and routing controller 104 to task performance controller 106 via an internal message bus. Data, such as function returned message may also be sent from task performance controller 106 to at least one of processing and routing controller 104 and dispatch controller 102 via at least one internal message bus. Task performance controller 106 may be configured to obtain processed and routed messages from processing and routing controller 104 and execute one or more skills/actions requested therein. In some inventive aspects, task performance controller 106 can include two functionalities—1) implementing an appropriate module of skill/action based on the routed message 2) managing admin portal (e.g., admin portal 114 in FIG. 11) interaction. This function is illustrated using a non-limiting example. Say a user sends an open ticket request via a bot. The open ticket request may be processed by dispatch controller 102 and processing and routing controller 104. The open ticket request may then be routed to a specific module in task performance controller 106. The task performance controller 106 may post this ticket on the admin portal via a communications platform/provider so that an administrator in the organization can view this ticket.

In some inventive aspects, task performance controller 106 calls/invokes the appropriate module of skill/action based on the domain and/or task in the routed message. The appropriate module then executes the skill/action. In some inventive aspects, task performance controller 106 initiates an outgoing response based on the incoming message. In some inventive aspects, task performance controller invokes a specific skill based on the incoming message. Upon execution of the skill, task performance controller 106 may return function returned message to processing and routing controller 104 to prepare a response via natural language generation or may return a function returned message directly to dispatch controller 102 to format the outgoing response in the schema of the outgoing communications platform/provider.

In some inventive aspects, one or more modules of skills/actions may involve an external service and therefore the one or more skills/actions may integrate with a third party service (e.g., Confluence™, Zendesk™, Twitter™). For example, say a task determined by an augmented router controller includes posting a Tweet™, then a module in task performance controller 106 that integrates with Twitter™ may be called. Third party services may be integrated in task performance controller 106 in one of two ways. First, by creating a special market place application that may be bundled up in such a way that the functionality of system 100 may be embedded into the product of the third party services. Second, by creating an authentication token that may be passed as a parameter every time a third party API is called via REST. In some inventive aspects, task performance controller 106 may be configured to access functionalities of processing and routing controller 104 and dispatch controller 102 via internal APIs.

According to some inventive aspects, an example code for a base skill set (i.e., entry point for performing skills via domains/tasks) is included below—

```
require Rails.root.to_s + ‘/lib/talla/skill.rb’
module Talla
  class BaseSkillSet
  include TimeHelper
  include NlgHelper
  include SkillHelper
  include ApplicationHelper
  attr_reader :message
  def self.invoke_outgoing(profile, bot, task, params)
    (module_name, task) = task.split(‘.’)
    mod = “Talla::#{module_name}”.constantize
    processor = mod::Processor.new(Conversation.new(:profile => profile, :bot =>
bot))
    processor.invoke(task, params)
  end
  def initialize(message)
    @message = message
  end
  # Invokes the provided skill name for an incoming message, first parsing the
  # externally-provided parameters using the skill's parameter definitions.
  #
  # @param [String] skill_name the skill to execute.
  # @param [Hash] parameters the externally-provided parameter hash
  def invoke_incoming(skill_name, parameters)
    skill = find_skill(skill_name)
    invoke(skill_name, skill.parsed_parameters(parameters, message.profile))
  end
  def invoke_with_processor(skill, context)
  (domain, task) = skill.split(‘.’)
  processor_for_skill(domain).invoke(task, context)
  end
  # Invokes the provided skill name with a set of parameters. Unlike
  # invoke_incoming, the parameters go through no further processing.
  #
  # @param [String] skill_name the skill to execute.
  # @param [Hash] parameters the parameters for the method.
  def invoke(skill_name, context)
  begin
    skill = find_skill(skill_name)
    context.reverse_merge!(default_context)
    if skill.validate.present?
    validation = method(skill.validate).call(context)
    return validation.merge(:conversation_uuid => context[‘_conversation_uuid’]) if
validation.present?
    end
    # do we have the require parameters? invoke directly - otherwise,
    # kick off an interaction to capture the required parameters
    if skill.required_parameters_present?(context)
    if script_state.script_name.nil?
      # Update to the last completed interaction. Only do this if not
      # in another script, as we don't want to clobber any active data.
      script_state.serialized_context[‘_last_skill’] = full_skill_name(skill_name)
      script_state.save!
    end
    response = method(skill_name).call(context)
    else
    # need to update start script to use the new rendering
    response = message.profile.start_script(full_skill_name(skill_name),
message.bot.id, context)
    response[:text] = response.delete(:body)
    response = respond(response)
    end
  rescue StandardError => e
    Rails.logger.error(“Failed to render response: #{e}, #{e.backtrace.join(“\n”)}”)
    NewRelic::Agent.notice_error(e)
    response = respond({
    :text => “Sorry, there's been an error, but my human friends will fix this problem
as soon as possible. Please try again later.”,
      :status => 500,
      :exception => e,
    })
    end
    return nil unless response.present?
    response.merge(:conversation_uuid => context[‘_conversation_uuid’])
  end
  # Prompts a user with the provided text to provide a yes/no confirmation.
  # The provided skill is then invoked with the provided true/false params.
  # Either set of params may be nil to indicate that no further action is
  # to be taken.
  def confirm(skill, true_params, false_params, response_options)
    response = respond(response_options)
    if response [:status] <= 300
    context = {“skill” => skill, “true_params” => true_params, “false_params” =>
false_params, “text” => response[:body]}.merge(existing_context)
    message.profile.start_script(“Default.confirmation”, message.bot.id,
context.merge!(default_context))
    end
    response
  end
  # A variation of confirm which also updates any newly provided parameters.
  # This should eventually replace the other one, but due to different
  # semantics, we'll leave them as separate until functionality is adapted.
  def confirm_or_update(skill, params, response_options)
    response = respond(response_options)
    if response [:status] <= 300
    context = {“skill” => skill, “params” => params, “text” =>
response[:body]}.merge(existing_context)
    message.profile.start_script(“Default.confirm_or_update”, message.bot.id,
context.merge!(default_context))
    end
    response
  end
  # Prompts a user for input of a new key with a provided type. The
  # provided skill is invoked with the new param merged in when the
  # input is matched.
  # @param [String] method_name the skill to invoke, Default.expect by default
  def expect(skill, params, key, format, response_options, method_name =
‘Default.expect’, script_params = { })
    response = respond(response_options)
    if response[:status] <= 300
    context = [“skill” => skill, “params” => params, “key” => key, “format” =>
format, “text” => response[:body]}.merge(existing_context)
    message.profile.start_script(method_name, message.bot.id,
context.merge(default_context).merge(script_params))
    end
    response
  end
  # A variation of expect which uses a notimeout script.
  def expect_no_timeout(skill, params, key, format, response_options)
    expect(skill, params, key, format, response_options, “Default.expect_no_timeout”)
  end
  def respond(params)
    text = ::Talla::Messages::Text.new(params[:text]) if params.has_key?(:text)
    text ||= ::Talla::Messages::Template.new(params[:template], self) if
params.has_key?(:template)
    text ||= ::Talla::Messages::Buffer.new(params[:buffer]) if params.has_key?(:buffer)
    text ||= ::Talla::Messages::Text.new(“”)
    options = [ ]
    if params.has_key?(:confidential)
    options << ::Talla::Messages::Confidential.new(params[:confidential])
    end
    if params.has_key?(:interaction)
    options << ::Talla::Messages::Interaction.new(params[:interaction])
    end
    if params.has_key?(:inplace_update)
    options << ::Talla::Messages::InplaceUpdate.new(params[:inplace_update])
    end
    messages = params[:messages] || [::Talla::Messages::build(text, options)]
    response_options = [ ]
    if params.has_key?(:status)
    response_options << ::Talla::Messages::Response::Status.new(params[:status])
    end
    if params.has_key?(:flag)
    response_options << ::Talla::Messages::Response::Flag.new(params[:flag])
    end
    result = ::Talla::Messages::Response::build(messages, response_options)
    if params[:exception]
    result[:error] = params[:exception].to_s
    result[:error_location] = params[:exception].backtrace.first.to_s
    end
    if params[:return_route]
    result[:return_route] = params[:return_route]
    end
    result
  rescue StandardError => e
    Rails.logger.error(“Failed to render response: #{e}, #{e.backtrace.join(“\n”)}”)
    NewRelic::Agent.notice_error(e)
    msg = {:body => “Sorry, an error occurred”}
    {:body => msg[:body], :messages => [msg], :status => 500, :error => e.to_s,
:error_location => e.backtrace.first.to_s}
  end
  # produces a formatted text response with status = 200. Used to indicate
  # success.
  def success_response(message, opts = { })
    respond(:text => message, :status => 200).merge(opts)
  end
  def success_response_with_params(message, params, opts = { })
    respond(params.merge(:text => message, :status => 200)).merge(opts)
  end
  # produces a formatted text response with status = 500. Used to indicate
  # we're not able to complete a task due to an internal error.
  def error_response(message, opts = { })
    respond(:text => message, :status => 500).merge(opts)
  end
  # Produces a formatted text response with status = 422. Used to indicate
  # we're not able to complete a task due to an error in user input.
  def invalid_response(message, opts = { })
    respond(:text => message, :status => 422).merge(opts)
  end
  # Produces a formatted text response with status = 422. Used to indicate
  # we're not able to complete a task due to an error in user input.
  def invalid_response_with_params(message, params, opts = { })
    respond(params.merge(:text => message, :status => 422)).merge(opts)
  end
  # Produces a formatted text response with status = 404. Used to indicate
  # we're not able to complete a task due to a missing resource.
  def not_found_response(message, opts = { })
    respond(:text => message, :status => 404).merge(opts)
  end
  def interaction_cancelled_response(opts = { })
    respond(:text => “#{nlg_cap(‘acknowledgement’)}, #{nlg(‘interaction_cancelled’)}.”,
:status => 202).merge(opts)
  end
  def tallachat_message?
    @message.return_route[“uri”].starts_with?(“tallachat”) if @message.return_route
  end
  private
  # @return [Hash] a context hash of default-context keys from the current script state.
Used to preserve the default context across scripts.
  def existing_context
    script_state.context.slice(default_context.keys)
  end
  def default_context
    {
    “channel” => message[“channel”],
    “_original_body” => message[“body”],
    “_conversation_uuid” => SecureRandom.uuid,
    }
  end
  def module_name
    self.class.parent.name.demodulize
  end
  def full_skill_name(skill_name)
    “#{module_name}.#{skill_name}”
  end
  def find_skill(skill_name)
    # Some skills don't have entries in skills.yml (eg internal helper-skills)
    Skill.find(full_skill_name(skill_name)) || Skill.new(:name =>
full_skill_name(skill_name))
  end
  def script_state
    @script_state ||= ScriptState.for_profile_id(message.profile_id, message.bot_id)
  end
  def processor_for_skill(domain)
    begin
    mod = “Talla::#{domain}”.constantize
    mod::Processor.new(message)
    rescue
    nil
    end
  end
  end
end
```

According to some inventive aspects, an example code for executing skills related to question answering is included below—

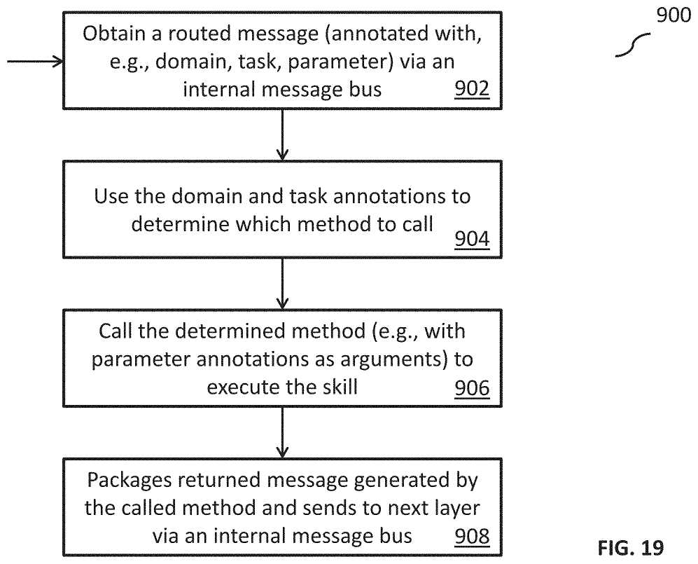

FIG. 19 is a flow diagram illustrating a method for task performance in accordance with some inventive aspects. In method 900, a message may be routed to appropriate module/component(s) within a task performance controller via an internal message bus. At 902, a task performance controller obtains the routed message from a processing and routing controller. In some inventive aspects, the routed message is associated/tagged with “domain,” “task,” “parameters,” another indicator, and/or a combination thereof. For example, the incoming message “schedule a meeting with Bob and Sally” may be classified as a “schedule_meeting” command, which is then processed to extract users named “Bob & Sally” in the user's organization to serve as an “attendees” parameter in the meeting scheduling. At 904, task performance controller 106 may determine a method/function to be called based on the annotations/tags in order to execute the skill/action and/or initiate an outgoing message. At 906, the determined method/function may be called to execute the specific skill, return a value, initiate an outgoing response and/or a combination thereof. In some inventive aspects, the annotations/tags may be used as parameters for the method/function. At 908, the function returned message from the called function/method may be sent to the next controller via an internal bus.

### Memory Device/Storage

One or more memory/storage devices 108 including for example, a database, may be communicatively coupled to dispatch controller 102, processing and routing controller 104, and/or task performance controller 106. In some inventive aspects, a memory device includes a cloud server such as Amazon Web Services™. A memory device may be in close physical proximity to or physically remote from system 100 or at least one component thereof. Information associated with messages and/or tasks may be stored in a memory device. Further, a memory device may be configured such that system 100 or at least one component thereof can readily access such information when necessary.

### Dispatch Controller (Outgoing Message)

In some exemplary implementations, the outgoing response messages are returned via the same communications platform as the incoming user request communications platform. In some inventive aspects, dispatch controller 102 may be configured to reroute messages to the user via an additional or different communications platform based on various factors, such as availability, effectiveness, cost, predetermined user preferences, etc. For example, if the user requests a task via a communications platform such as Slack™, and Slack™ becomes unavailable, dispatch controller 102 may opt to re-route a return outgoing message to the same user via a different communications platform such as SMS.

Dispatch controller 102 may be further configured to reformat the function returned message according to the schema of the intended communications platform/provider. In some inventive aspects, dispatch controller 102 obtains the function returned message from the other components/controllers of the system 100 in a standard format. In general, these messages need to be reformatted to be the schema of intended communications platform. For example, some communications platforms support HyperText Markup Language (HTML) text formatting, in which case function returned messages are converted from the standard format of the inventive aspect to an HTML format before being transmitted via the bot to these communications platforms/providers. Some communications platforms use other formats such as Markdown, Extensible Markup Language (XML), Standard Generalized Markup Language (SGML), an audio compression format (e.g., MP3, AAC, Vorbis, FLAC, and Opus), a video file format (e.g., WebM, Flash Video, Vob, GIF, AVI, M4V, etc.), and others. Function returned messages are reformatted and/or converted accordingly.

FIG. 20 is a flow diagram illustrating a method for dispatching an outgoing schema message in accordance with some inventive aspects. At 1002, a first controller (e.g., dispatch controller) in a system may obtain a function returned message from a second controller (e.g., processing and routing controller and/or task performance controller) in the system. The function returned message obtained from the second controller via an internal message bus may be in a standard format (e.g., JSON). At 1004, the system may include at least one processor (e.g., processor 306 in FIG. 3) to process identifiers associated with the function returned message. Some examples of identifiers may include user-identity, communication platform/platform, type of response message, etc. At 1006, the system may determine the communication platform/provider for sending the outgoing message. In some inventive aspects, the communication platform for outgoing responses may be the same as the communication platform for incoming messages. In other inventive aspects, the incoming and outgoing communication platforms may vary. In some inventive aspects, if a communication platform for sending outgoing message does not respond, the system may dynamically determine a different communication platform for sending the same response. At 1008, one or more processors included in the first controller may convert the function returned message to a schema of the communication platform determined in the previous step.

### Bot (Outgoing Message)

The outgoing schema message in the schema of the communication platform/provider is pushed to the bot. At the provider, the provider transforms the output schema message into natural language format. The outgoing message in natural language format is delivered to the user via the bot through the determined communication platform/provider.

### Admin Portal

In some inventive aspects, system 100 can include an admin portal (e.g., admin portal 114 in FIG. 11) that functions as an interface to one or more administrators within an organization (e.g., organization 124 in FIG. 11). The administrators can monitor and respond to incoming messages from user via admin portal 114. Some non-limiting functionalities of admin portal 114 include:
1) Enabling creation and definition of workflows.
2) Enabling administrators to review incoming messages from users. For example, an administrator (e.g., a service desk professional) may login to system 100 via admin portal 114 and review incoming requests (e.g., open tickets) from users.
3) Enabling administrators to search a memory/knowledgebase (e.g., memory 108 in FIG. 11) to determine a response to a user query. In some such instances, users may have read only access to the knowledgebase while the administrators may have access to modify content in the knowledgebase.

In some inventive aspects, admin portal (e.g., admin portal 114 in FIG. 11) may be used to design and generate workflows as disclosed herein.

### Example

The process of obtaining, processing, and executing an incoming message by system 100 is further illustrated with the following non-limiting example. A user types a message “Add task to ‘complete documentation’ due 4 P.M.” into a bot via Slack™ on Sep. 15, 2016. Slack™ transforms the incoming message to a schema associated with Slack™. The transformed message/incoming schema massage is pushed to dispatch controller 102. Dispatch controller 102 receives the incoming schema message at a module that corresponds to Slack™. Dispatch controller 102 may then match the user to an internal profile of a known user of system 100. After the user is matched to an internal profile, dispatch controller 102 packages the message by annotating the message with identifiers associated with the message and/or user. The annotation may include the platform for obtaining the incoming message/message source [slack], user profile id [12345], organization bot id [123], and/or other initial basic information for interpreting the incoming message and routing a possible response. In some inventive aspects, the annotated message is packaged as a JSON string and the initial formatted message is sent to processing and routing controller 104 via an internal message bus such as nanomsg™ (available from nanomsg.org).

Processing and routing controller 104 obtains the initial formatted message from dispatch controller 102. Processing and routing controller 104 may run the user's message through at least one message attribute processing controller. In this example, a “DateIntent” processing controller identifies “4 P.M.” as a datetime value. The message attribute processing controller may remove the datetime value from the initial formatted message body, and annotate the message with the expression extracted_time_intents=[(2016, 09, 15, 16, 0)], which corresponds to 4 P.M. on the day the incoming message was sent. Processing and routing controller 104 may run a copy of the augmented message through at least one augmented message router. A particular augmented message router may or may not respond to a particular augmented message. However, if an augmented message router responds to a message, it may further extract and/or annotate a router-specific copy of the message including a domain and a task associated with the message (e.g., a user intent, any extracted parameters needed for that intent, and/or a probability score for how confident the router is in determining the user intent and subsequently executing the task/initiating an outgoing response). In this example, a regular expression message router (Regex Router) matches this message as it directly matches a pattern−/add task to “(.*)” due (.*)/with domain=“Tasks”, task=“create_task”, parameters={title=“complete documentation”}. Processing and routing controller 104 may implement a decision policy to select a routed task and send the fully annotated message/routed message associated with that routed task to task performance controller 106, via the internal message bus.

Task performance controller 106 obtains the routed message from processing and routing controller 104. Task performance controller 106 may use the domain and task annotations to determine the method that needs to be called to execute the task. In this example, the method Tasks::Processor.create_task(message[“parameters”]) is called. Task performance controller 106 sends the return message/function returned message generated by the called method to dispatch controller 102 via the internal message bus.

Dispatch controller 102 obtains the function returned message from task performance controller 106. Dispatch controller 102 takes the function returned message and may format it to a schema associated with the Slack™ application/system. Slack™ transforms the outgoing schema message to natural language format. The outgoing message may be sent via the Slack™ API to the user such that the user receives a response from system 100 via the bot (e.g., on a display).

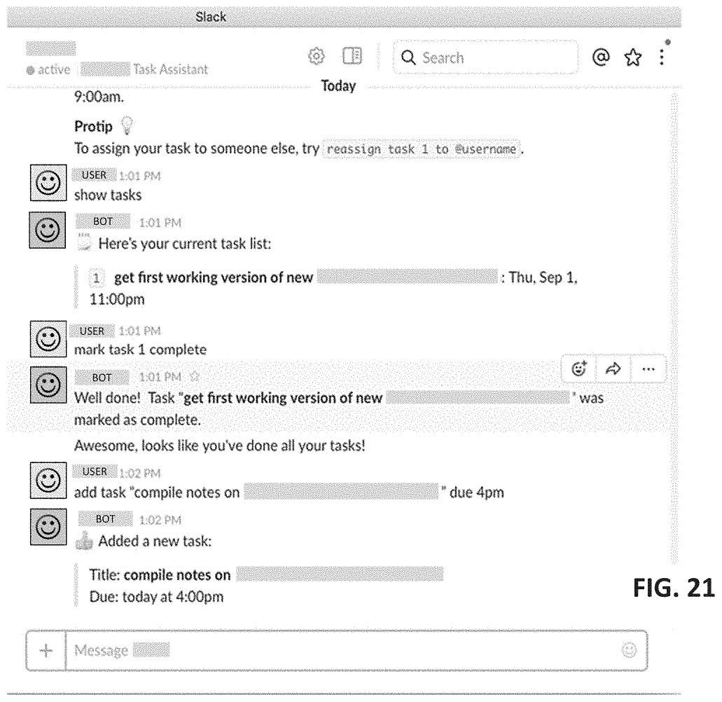

FIG. 21 is a screenshot of a display illustrating a user interface/bot interface for making requests and receiving response in accordance with some inventive aspects. In the example shown, a user sends requests to a chatbot designed according to some inventive aspects described herein.

In this example, a user communicates with the chatbot using the chat client Slack™ as a communications platform. For example, the user sends the first request, “show tasks,” intending to review outstanding tasks associated with the user's account. The chatbot receives the first request via Slack™, resolves user-identity associated with the first request, formats the first request to a standard format, processes and modifies the first request by identifying specific features, determines user intent underlying the first request, routes the first request (e.g., based on machine learning techniques), performs a first task of collecting data regarding the outstanding tasks associated with the user, and/or generates a first response for the user. In some inventive aspects, the chatbot also determines a communications platform to deliver the first response to the user. In this example, the chatbot uses the same communications platform from which it obtained the first request to deliver the first response, that is, “Here's your current task list . . . ,” with a display of the outstanding tasks associated with the user.

Next, the user sends a second request to “mark task 1 complete.” The chatbot similarly processes this second request, performs a second task of modifying the data regarding the outstanding tasks associated with the user, and returns a second response, “Well done! . . . you've done all your tasks.” The user further sends a third request to add a task to the list of the outstanding tasks. The chatbot similarly processes this third request, performs a third task of further modifying the data regarding the outstanding tasks associated with the user, and returns a third response with a confirmation of the added task, the title of the task, and the due date and time for the task.

### Workflows Within the Example Architecture

In some inventive aspects, system 100 is used to create, initiate, and/or execute a workflow. A workflow is used herein to refer to a structured representation of steps that may define how system 100 interacts with users, including expected inputs from the user. In other words, workflow is a wireframe that interacts with users of system 100. A workflow may include one or more work units that are actions that system 100 executes. The outcome of implementing a work unit represents a state within a workflow such as the status of the workflow. One or more predetermined actions or triggers operate to transition workflow from work unit and thus one state within a workflow to another work unit and thus another state, for example, the next work unit or state within a linear workflow. Thus, workflows may be defined as Finite State Machines (FSMs) that represent a sequence of work units.

In some inventive aspects, FSMs representing workflows are linear. That is, one or more triggers operate to transition workflows from one work unit and thus one state to the next work unit and thus next state. In other inventive aspects, FSMs representing workflows are cycles and/or branches.

In some inventive aspects, system 100 includes standard templates to create a workflow. The templates may be predetermined based on the needs of an organization and/or an individual interacting with system 100. In other inventive aspects, an application included in system 100 enables creation of a workflow dynamically without the use of a template. A workflow may be designed dynamically or using a standard template by one or more users.

In some inventive aspects, a workflow is created from a design by a single user. Multiple other users may have access to that workflow. That is, multiple other users may add and/or change work units and triggers of that workflow. In other inventive aspects, one workflow is created by multiple users and one or more users may have access to that workflow.

In some inventive aspects, once the workflow is created and access to the workflow is determined, the workflow may be assigned to one or more users for execution. In some inventive aspects, a workflow is created by a single user such as an administrator of an organization and can be assigned to multiple users at a later time. In other inventive aspects, once the workflow is created, it is assigned to a single user.

In some inventive aspects, a workflow is initiated for a single user and is executed by that user. In other inventive aspects, a workflow is initiated for multiple users and may be executed by multiple users. In some inventive aspects, a single instance of a workflow is created. In other inventive aspects, multiple instances of the same workflow may be created. Multiple users may execute same instance of the created workflow or multiple instances of the created workflow. In some inventive aspects, a work flow is initiated by user actions, time delay, third part action, and/or by an artificial intelligence (AI) agent.

In some inventive aspects, an application that includes workflow components may reside in task performance controller 106 of system 100. When a work unit is triggered within a workflow the outcome from the work unit (e.g., result of a task executed and/or an outgoing message to the user) may be sent to dispatch controller 102. In some inventive aspects, the outcome from the work unit is sent directly to dispatch controller 102. In other inventive aspects, the outcome from the work unit is sent to dispatch controller 102 via processing and routing controller 104. In some inventive aspects, when a work unit of a workflow is triggered, the outcome from that work unit may trigger another work unit within task performance controller 106.

In some inventive aspects, system 100 may receive a user request in the form of an incoming message to initiate a workflow. The incoming message may be formatted, processed, routed and executed using the methods disclosed in the sections above. That is, dispatch controller 102, processing and routing controller 104 and task performance controller 106 included in system 100 may format the incoming message to a standard format, process and modify the incoming message by identifying specific features, determine user intent underlying the incoming message, route the formatted and processed message and perform the task of initiating the workflow. Thus, the first work unit defined in a work flow may be initiated in task performance controller 106.

### Application Program Interfaces (APIs)

In some inventive aspects, API(s) included in system 100 is integrated with one or more third party APIs. Integration of one or more third party APIs may enable services such as “If This Then That”. That is, simple connections may be created between applications and connected devices using chains of simple conditional statements triggered by changes/events. For example, a workflow to broadcast message to a user depending on the information included in an incoming message may use If This Then That—type service. If the incoming message includes a hashtag, API code related to Twitter® may be accessed to broadcast the message via Tweet™. However, if the incoming message includes a subject line, API code related to Google apps™ may be accessed to broadcast the message via Gmail™. Thus, in addition to platform agnostic messaging, system 100 enables platform agnostic function/task execution. That is, system 100 may communicate with one or more functional platforms such as web services like a social media, email, or a calendar.

To illustrate further, if system 100 executes a work unit within a workflow, and the work unit may be executed via one or more platforms such as Twitter® or calendar, then platforms Twitter® and calendar used to execute a work unit may be defined as a functional platform. In addition to being message platform agnostic, system 100 is also functional platform agnostic. For example, if a work unit within a workflow is to block off a meeting time in a users' calendar then task performance controller 106 may access the API code related to calendar and update users calendar via the calendar API code. However, if a work unit within workflow is to broadcast a message on social media such as Facebook® then task performance controller 106 may access the API code related to Facebook® and broadcast the message on Facebook® via its API code. Thus, a task may be executed on a platform external to system 100.

In some inventive aspects, one or more APIs and/or API code related to different functional platforms may be stored in task performance controller 106. When a work unit within a workflow necessitates integrating an external platform, then task performance controller 106 may access the API code related to corresponding external functional platform to execute the work unit via that external platform. Task performance controller 106 may include one or more memory/storage devices to store API codes relating to a plurality of functional platforms. In some inventive aspects, data within a work unit is processed via processing and routing controller 104 to process and route the data within work unit to the appropriate functional platform API within task performance controller 106. Task performance controller 106 may access the API code of appropriate functional platform identified in the processing and routing controller and execute the task within the work unit via the appropriate functional platform.

For example, if a work unit includes a message with hashtag, then the message may be sent to processing and routing controller 104. Processing and routing controller 104 recognizes from the hashtag that the message is a Tweet™, it then determines if user of the workflow has an authorized Twitter® account. Once the authorized Twitter® account is found, a routed message including a token indicating that Twitter® API needs to be accessed may be sent to task performance controller 106. Task performance controller 106 may then access Twitters' API code to drop the message on Twitters' interface. In a similar manner, if a work unit within a workflow includes a message to schedule a meeting, the message may be sent to processing and routing controller 104 for processing. Processing and routing controller 104 may implement machine learning techniques and route the message by including a token within the routed message indicating that calendar API code needs to be accessed. The routed message may be sent to task performance controller 106 that accesses API code of calendar and updates the calendar via its interface.

Other examples of API formats of functional platforms within task performance controller 106 may include Google Apps™ service, Microsoft®, Office 365® apps, Trello™, Salesforce®, Google Drive™ search, and one or more weather APIs.

In some inventive aspects, workflows are initiated via one or more functional platforms. For example, an organization that performs automated tasks via Salesforce® may initiate a workflow within system 100 following a client inquiry. That is, every time there is a client inquiry Salesforce® API may interact with system 100 API to initiate the workflow.

### Examples of Workflow User Experience Design

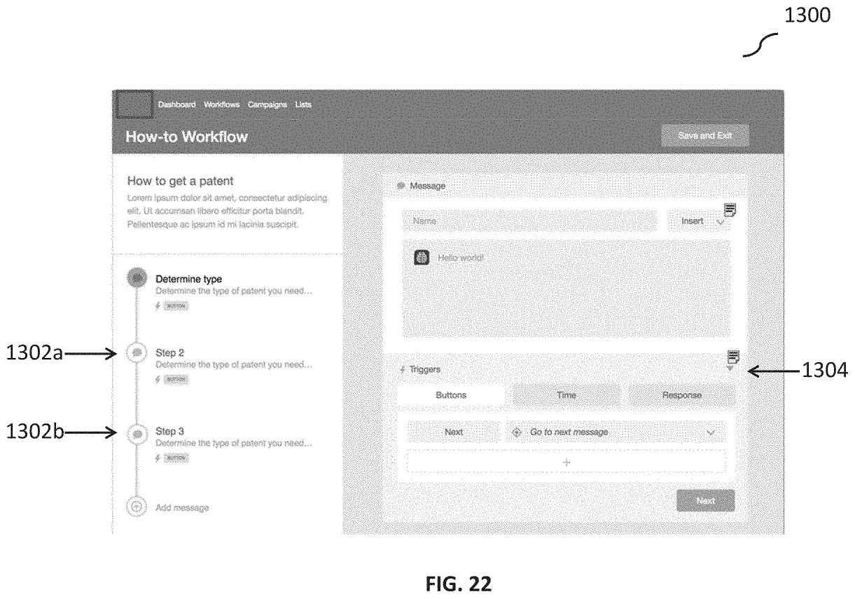

FIG. 22 illustrates a user interface 1300 for designing a workflow in accordance with some inventive aspects. User interface 1300 may include work units that may be user defined such as 1302a, 1302b, collectively 1302. In some inventive aspects, triggers 1304 may be defined by a user. A trigger may be set as a message, a time when a work unit may need to triggered, a response that may trigger a work unit, and/or, a button that may trigger a work unit.

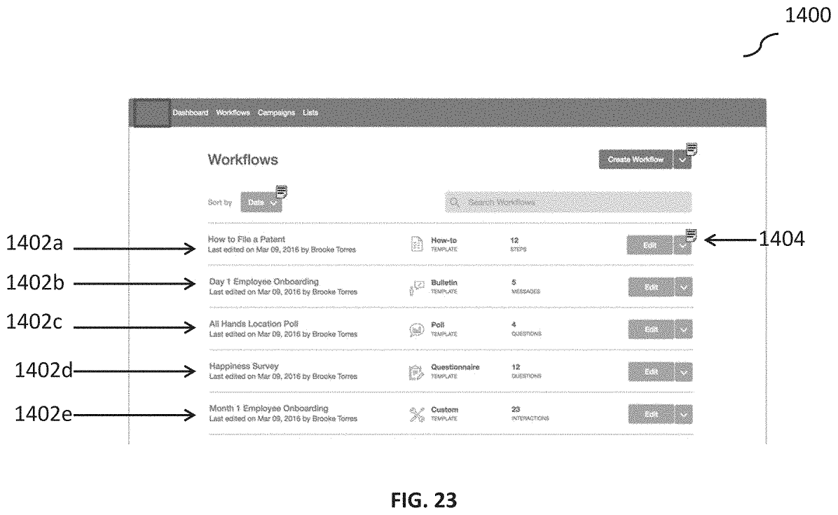

FIG. 23 illustrates a user interface 1400 that enables editing a workflow in accordance with some inventive aspects. The user interface 1400 may list one or more workflows 1402 for example, 1402a-e that may have been created at an earlier time. As illustrated in FIG. 14 each workflow 1402 may be available to a user for editing via an edit button 1404.

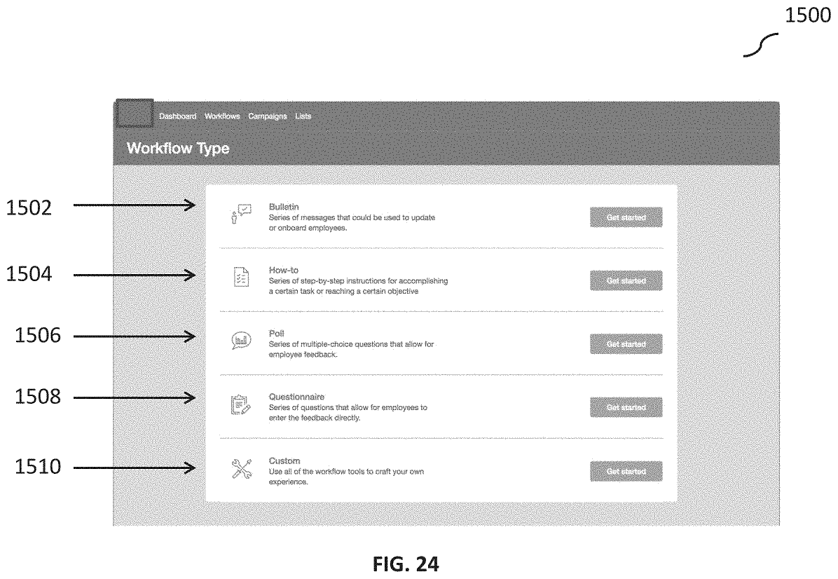

FIG. 24 illustrates a user interface 1500 that enables designing a workflow based on predefined templates in accordance with some inventive aspects. For example, template 1502 may be used to create a workflow to send a series of messages used to update or onboard employees. Template 1504 may be used to create a workflow with a series of step-by-step instructions for accomplishing a certain task or reaching a certain objective. Template 1506 may include a series of multiple-choice questions for employee feedback. Template 1508 may allow employees to enter their feedback directly. Template 1510 may allow a user to design a customized workflow.

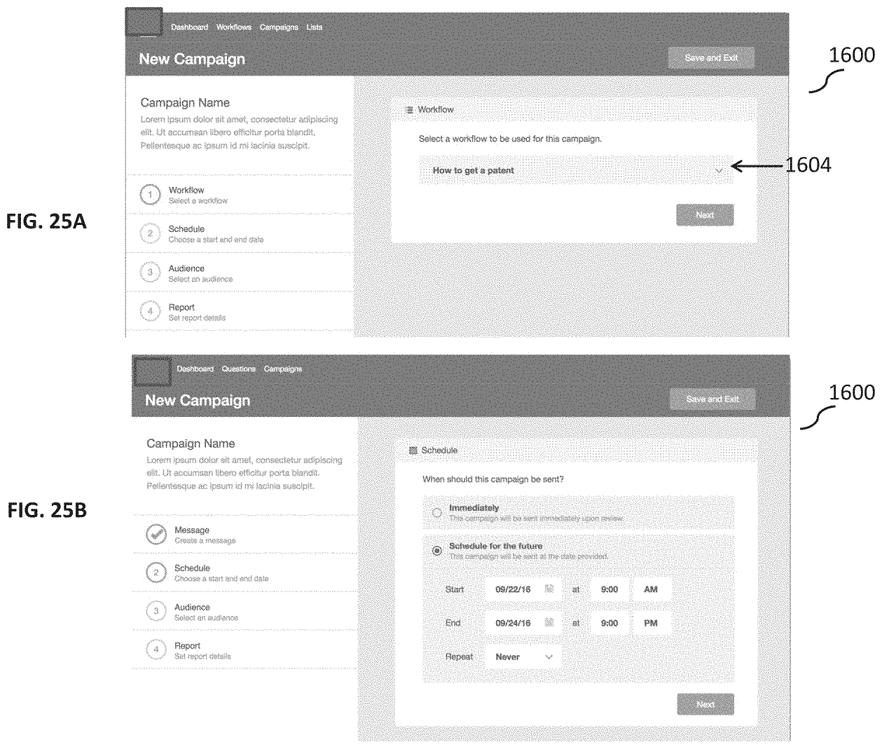

FIG. 25A and 25B illustrates a user interface 1600 that enables designing a campaign in accordance with some inventive aspects. In FIG. 25A, a user may define a workflow that the campaign initiates. In some inventive aspects, the user defines a workflow that has been previously created. For example, a drop down menu such as 1604 may be presented to the user with a list of previously created workflows. In other inventive aspects, the user defines a new workflow that is designed after the design of the campaign is complete. In FIG. 25B the user may define a time that a campaign may be sent. A campaign may be scheduled immediately or for a later time. In some inventive aspects, if a campaign is scheduled for a later time, the user interface 1600 may enable a user to input the start time and the end time for the campaign. The user may also choose a frequency option to repeat the campaign.

FIG. 27 illustrates a user interface 1700 that enables a campaign in accordance with some inventive aspects. The user interface 1700 may list one or more campaigns 1702 for example, 1702a, 1702b, and 1702c that have been created at an earlier time. In some inventive aspects, if a campaign (e.g., 1702a) that was created at an earlier time has been initiated and executed then, the status of the campaign is shown as complete and a view report button 1704 available to a user to view the report generated from the campaign. In addition, a campaign that may be initiated but not executed in its entirety, or a campaign that may not be initiated or executed may be available to the user for editing via an edit button 1706.

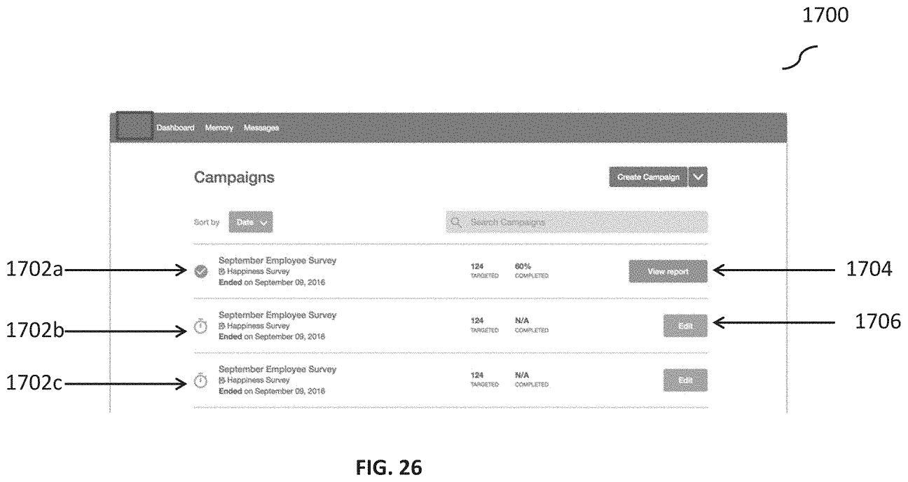

FIG. 26 illustrates a dashboard 1700 that enables editing 1706 a campaign 1702 for example, 1702b and 1702c that has been created. In addition, once a campaign is complete for example, 1702a, dashboard 1700 enables viewing a report 1704 generated by campaign 1702a.

### Conclusion

While various inventive aspects have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive aspects described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive aspects described herein. It is, therefore, to be understood that the foregoing inventive aspects are presented by way of example only and that, within the scope of the appended claims and equivalents thereto, inventive aspects may be practiced otherwise than as specifically described and claimed. Inventive aspects of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described inventive aspects can be implemented in any of numerous ways. For example, inventive aspects may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, inventive aspects may be constructed in which acts are performed in an order different than illustrated, which may include performing some acts simultaneously, even though shown as sequential acts in illustrative inventive aspects.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one inventive aspect, to A only (optionally including elements other than B); in another inventive aspect, to B only (optionally including elements other than A); in yet another inventive aspect, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one inventive aspect, to at least one, optionally including more than one, A, with no B present (and optionally including elements other than B); in another inventive aspect, to at least one, optionally including more than one, B, with no A present (and optionally including elements other than A); in yet another inventive aspect, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system to improve computer network functionality relating to natural language communication, the system comprising:
at least one communication interface to communicatively couple the system to at least one computer network;
a memory; and
a processor communicatively coupled to the memory, the processor configured to implement:
a state machine that is configured to implement an instance of a workflow to facilitate natural language communication with an entity, the state machine comprising:
a transition comprising a work unit to execute at least one computer-related action relating to the natural language communication with the entity, wherein:
the work unit is triggered by an event; and
the state machine is in an outcome state upon completion of the work unit; and
an artificial intelligence (AI) agent, comprising an AI communication interface communicatively coupled to the at least one communication interface and the state machine, configured to receive state machine information from at least the state machine and implement at least one machine learning technique to process the first state machine information to determine state machine observation information regarding a behavior or a status of the state machine.

2. The system of claim 1, wherein the at least one machine learning technique implemented by the AI agent to process the state machine information includes at least one of maximum entropy classification, Naive Bayes classification, k-Nearest Neighbors (k-NN) clustering, Word2vec analysis, dependency tree analysis, n-gram analysis, hidden Markov analysis and probabilistic context-free grammar.

3. The system of claim 1, wherein the state machine information includes at least one of state information and work unit information.

4. The system of claim 3, wherein:
the state machine information includes the state information;
the state information includes:
a first outcome state indicator to indicate when the state machine is in the first outcome state; and
a second outcome state indicator to indicate when the state machine is in the second outcome state; and
the state machine observation information includes:
at least one first indicator time at which the AI agent receives the first outcome state indicator; and
at least one second indicator time at which the AI agent receives the second outcome state indicator.

5. The system of claim 4, wherein the state machine observation information includes a state history of the state machine, and wherein the state history includes a plurality of time intervals between successive outcome states of the state machine.

6. The system of claim 3, wherein:
the state machine information includes the work unit information;
the work unit comprises at least one of:
at least one input interface to receive work unit input information; and
at least one output interface to provide work unit output information based at least in part on the at least one computer-related action executed by the work unit; and
the work unit information includes at least one of:
at least some of the first work unit input information; and
at least some of the first work unit output information.

7. The system of claim 6, wherein:
the state machine information includes the state information;
the state information includes:
a first outcome state indicator to indicate when the state machine is in the first outcome state; and
a second outcome state indicator to indicate when the state machine is in the second outcome state; and
the state machine observation information includes:
at least one first indicator time at which the AI agent receives the first outcome state indicator; and
at least one second indicator time at which the AI agent receives the second outcome state indicator.

8. The system of claim 1, wherein:
the AI agent further comprises at least one decision policy to implement a non-deterministic function based on an objective; and
the AI agent determines the state machine observation information based at least in part on the non-deterministic function.

9. The system of claim 1, wherein the AI agent includes means for determining the state machine observation information.

10. (canceled)

11. The system of claim 1, wherein the entity is at least one of:
at least one human user; and
the AI agent.

12. The system of claim 1, wherein:
the work unit comprises at least one input interface to monitor work unit input information; and
the at least one computer-related action executed by the work unit is based at least in part on the monitored work unit input information.

13. (canceled)

14. The system of claim 1, wherein:
the work unit comprises at least one output interface to provide work unit output information based at least in part on the at least one computer-related action executed by the work unit.

15. The system of claim 1, wherein the work unit output information includes at least one of:
outgoing database information to store in a database;
outgoing entity information for the entity; and
an outgoing natural language message for the entity.

16. The system of claim 1, wherein the work unit comprises means for executing the at least one computer-related action.

17. (canceled)

18. The system of claim 1, wherein the work unit comprises a work unit AI agent to execute the at least one computer-related action based at least in part on implementing at least one work unit machine learning technique.

19. (canceled)

20. The system of claim 1, wherein the system further comprises at least one memory including a database, and wherein the at least one computer-related action executed by the work unit and relating to the natural language communication with the entity comprises at least one of:
retrieving first information from the database;
storing second information in the database;
creating an electronic calendar entry relating to the entity;
sending third information to the entity;
receiving fourth information from the entity;
sending a first natural language message to the first entity; and
receiving a second natural language message from the first entity.

21-23. (canceled)

24. The system of claim 20, wherein:
sending a first natural language message to the entity comprises sending a first natural language question to the entity to prompt a first natural language response by the entity; and
receiving a second natural language message from the entity comprises receiving the first natural language response to the first natural language question.

25. The system of claim 20, wherein:
sending a first natural language message to the entity comprises sending a first poll to the entity to prompt a first poll response by the entity; and
receiving a second natural language message from the entity comprises receiving the first poll response.

26. The system of claim 20, wherein:
sending a first natural language message to the entity comprises sending a first approval request to the entity to prompt a first approval response by the entity; and
receiving a second natural language message from the entity comprises receiving the first approval response.

27. The system of claim 20, wherein:
the entity uses a third-party communication platform for the natural language communication; and
the at least one computer-related action executed by the work unit includes accessing at least one third party Application Programming Interface (API) to facilitate the natural language communication with the entity.

28. The system of claim 27, wherein the at least one third party API includes at least one of:
a Twitter® API;
a Google apps™ API;
a Facebook® API;
a Microsoft® API;
an Office 365® apps API;
a Trello™ API;
a Salesforce® API;
a Google Drive™ search API; and
at least one weather API.

29-33. (canceled)

34. The system of claim 1, wherein the transition is a first transition; the work unit is a first work unit; the computer-related action is a first computer-related action; the event is a first event, the state machine further comprising:
a second transition comprising a second work unit to execute at least one second computer-related action relating to the natural language communication with the first entity, wherein:
the second work unit is triggered by a second event when the state machine is in the outcome state.

35. The system of claim 1, wherein the transition is a first transition; the work unit is a first work unit; the computer-related action is a first computer-related action; the event is a first event; the outcome state is a first outcome state, the state machine further comprising:
a second transition comprising a second work unit to execute at least one second computer-related action relating to the natural language communication with the first entity, wherein:
the state machine is in a second outcome state upon completion of the second work unit; and
the first event triggers the first work unit when the first state machine is in the second outcome state.

36. The system of claim 1, wherein the event is at least one of:
at least one first action by at least one of the first entity and a third party;
external sensor feedback;
a scheduled date;
a scheduled time;
a relative time;
a first work unit input to the work unit;
a first work unit output from the work unit; and
system activity of the system.

37-38. (canceled)

39. The system of claim 1, wherein the AI agent generates the event that triggers the work unit based at least in part on at least one machine learning technique.

40. The system of claim 39, wherein the AI agent dynamically generates the event based at least in part on the at least one machine learning technique and at least one of:
at least one first AI input received via the at least one communication interface; and
at least some of the state machine information received from the state machine.

41. (canceled)

42. The system of claim 1, further comprising:
a second state machine, communicatively coupled to the AI agent, to implement a second instance of the workflow to facilitate second natural language communication with a second entity, the second state machine comprising:
the transition comprising the work unit to execute the at least one computer-related action relating to the second natural language communication with the second entity, wherein:
the work unit is triggered by a second state machine event; and
the second state machine is in the outcome state upon completion of the work unit.

43. A system to improve computer network functionality relating to natural language communication, the system comprising:
at least one communication interface to communicatively couple the system to at least one computer network;
a memory; and
a processor communicatively coupled to the memory, the processor configured to implement:
a state machine configured to implement an instance of a workflow to facilitate natural language communication with an entity, the state machine comprising:
a transition comprising a work unit to execute at least one computer-related action relating to the natural language communication with the entity, wherein:
the work unit is triggered by an event; and
the state machine is in an outcome state upon completion of the work unit; and
an artificial intelligence (AI) agent, communicatively coupled to the at least one communication interface and the state machine, configured to implement at least one machine learning technique to dynamically generate at least the event that triggers the work unit.

44. The system of claim 43, wherein the at least one machine learning technique implemented by the AI agent includes at least one of maximum entropy classification, Naive Bayes classification, k-Nearest Neighbors (k-NN) clustering, Word2vec analysis, dependency tree analysis, n-gram analysis, hidden Markov analysis and probabilistic context-free grammar.

45-85. (canceled)

86. A system to improve computer network functionality relating to natural language communication, the system comprising:
at least one communication interface to communicatively couple the system to at least one computer network;
a memory; and
a processor communicatively coupled to the memory, the processor configured to implement:
a first state machine to implement a first instance of a workflow to facilitate first natural language communication with a first entity, the first state machine comprising:
a first plurality of work units to execute first respective computer-related actions relating to the first natural language communication with the first entity, the first plurality of work units respectively triggered by a corresponding plurality of first state machine events and having a corresponding plurality of first state machine outcome states; and
a second state machine to implement a second instance of the workflow to facilitate second natural language communication with a second entity, the second state machine comprising:
a second plurality of work units to execute the first respective computer-related actions relating to the second natural language communication with the second entity, the second plurality of work units respectively triggered by a corresponding plurality of second state machine events and having a corresponding plurality of second state machine outcome states,
wherein at least one of the plurality of first state machine events in the first state machine is based on the second state machine being in one of the plurality of second state machine outcome states.

87-126. (canceled)
